(19) United States
(12) Patent Application Publication
(10) Pub. No.: US 2021/0317283 A1
(43) Pub. Date: Oct. 14, 2021

(54) AEROGEL MATERIALS AND METHODS FOR THEIR PRODUCTION

(71) Applicant: Aerogel Technologies, LLC, Boston, MA (US)

(72) Inventors: Stephen A. Steiner, III, Milwaukee, WI (US); Justin S. Griffin, Watertown, MA (US); Ryan T. Nelson, Medford, MA (US)

(73) Assignee: Aerogel Technologies, LLC, Boston, MA (US)

(21) Appl. No.: 17/104,044

(22) Filed: Nov. 25, 2020

Related U.S. Application Data
(63) Continuation of application No. 15/562,950, filed on Sep. 29, 2017, now abandoned.
(60) Provisional application No. 62/141,221, filed on Mar. 31, 2015.

(51) Int. Cl. C08J 9/28; C08G 18/32; C08G 18/09; C08G 18/20; C08G 18/34; C08G 18/28; C08G 18/24; C08G 18/76; C08G 18/79; C08G 18/18; C08G 18/78; C08G 18/30; C08G 18/38; C08G 18/73; C08G 69/00; C08G 73/10

(52) U.S. Cl. CPC C08J 9/28; C08J 2379/08; C08G 18/092; C08G 18/2036; C08G 18/3243; C08G 18/346; C08G 18/289; C08G 18/246; C08G 18/7657; C08G 18/7664; C08G 18/792; C08G 18/18; C08G 18/7831; C08G 18/30; C08G 18/3819; C08G 18/73; C08G 18/7671; C08G 69/00; C08G 73/1003; C08J 2201/0502; C08J 2375/04; C08J 2205/026; C08G 2110/0058; C08G 2110/0066; C08G 2110/0091; C08G 2115/02; C08J 2375/02; C08J 2377/00; C08G 18/3215

(57) ABSTRACT

The present disclosure generally relates to aerogel materials and methods for producing them.

### RELATED APPLICATIONS

This application is a continuation of U.S. patent application Ser. No. 15/562,950, filed Sep. 29, 2017, and entitled “Aerogel Materials and Methods for their Production”; which is a U.S. national stage application of International Patent Application No. PCT/US2016/025282, filed Mar. 31, 2016, and entitled “Aerogel Materials and Methods for their Production”; which claims priority under 35 U.S.C. § 119(e) to U.S. Provisional Patent Application No. 62/141,221, filed Mar. 31, 2015, and entitled “Aerogel Materials and Methods for their Production,” each of which is incorporated herein by reference in its entirety for all purposes.

### BACKGROUND

### 1. Field

Aspects described herein relate to aerogel materials and methods for their production.

### 2. Discussion of Related Art

Aerogels are a diverse class of low-density solid materials comprised of a porous three-dimensional network of interconnected nanostructures. Aerogels often exhibit a wide array of desirable materials properties including high specific surface area, low bulk density, high specific strength and stiffness, low thermal conductivity, and low dielectric constant, among others.

Certain aerogel compositions may combine several of these properties into the same material envelope and may thus be advantageous for applications including thermal insulation, acoustic insulation, lightweight structures, impact damping, electrodes, catalysts and catalyst supports, and sensors. Some aerogel materials possess mechanical properties that make them suitable for use as structural materials and, for example, can be used as lightweight alternatives to plastics.

Production of aerogel materials typically involves time-intensive, diffusion-limited processes and throughput-limiting batch manufacturing. Methods that enable rapid production of aerogel materials from gel precursors, that enable continuous production of aerogel monoliths or blankets, and/or that do not limit products to the dimensions of a pressure vessel are particularly desirable.

### SUMMARY

The present disclosure generally relates to aerogel materials and methods for producing them, for example, manufacturing of aerogels that does not require supercritical drying as part of the manufacturing process. In some cases, certain combinations of materials, solvents, and processing steps may be synergistically employed so as to enable manufacture of large (e.g., meter-scale), substantially crack-free, mechanically strong aerogel monoliths. In some cases, certain combinations of materials, solvents, and processing steps may be synergistically employed as so to enable manufacture of aerogel monoliths, blankets, and thin films in a continuous manner. In some cases, certain combinations of materials, solvents, and processing steps may be synergistically employed as to enable additive manufacturing of aerogel materials.

For instance, upon forming a porous gel (e.g., derived from a sol), solvent located within the pores of the gel may be exchanged with an organic solvent that allows for subcritical drying and formation of an aerogel at ambient conditions. That is, after suitable solvent exchange occurs, by simply allowing the organic solvent to evaporate, without further manipulation, an aerogel having desirable characteristics may automatically form. Such an organic solvent may include fluorine and oxygen, may be non-flammable, and may exhibit a low surface tension (e.g., less than 20 dynes/cm, less than 15 dynes/cm).

As provided herein, aerogel materials that are not manufactured by supercritical drying with carbon dioxide may be prepared. For example, as discussed above, methods described herein may allow for the production of aerogel materials under atmospheric or otherwise ambient conditions. Accordingly, rigid aerogel monoliths and flexible aerogel materials may be prepared with dimensions not limited to or otherwise requiring the use of a heavy-wall pressure vessel. That is, such pressure vessels, as traditionally employed, are not required by certain embodiments of the present disclosure. In some embodiments, the solvent dispersed throughout the pores/channels of a gel may be removed by evaporation under ambient atmospheric or other similar conditions.

For example, aerogel materials in accordance with the present disclosure may have superior mechanical properties compared with conventional aerogel materials, be manufactured without the use of a supercritical dryer, and have desirable thermal insulating, acoustic damping, non-flammability, and machinability properties. Continuous manufacturing of aerogel materials in accordance with the present disclosure may be performed, for example, with a process where a gel is cast, its pore fluid is exchanged for a new pore fluid, and the new pore fluid is removed, in a continuously moving fashion or roll-to-roll process, within a matter of hours.

The methods herein may take one of several forms, each with different advantages. In some embodiments, aerogel materials may be prepared from gel precursors in a matter of a few hours or even a few minutes. In some embodiments, the resulting aerogel materials may have desirable mechanical properties, thermal insulating properties, acoustic damping properties, non-flammability, and machinability properties.

In an illustrative embodiment, a method for manufacturing aerogels is provided. The method includes forming a porous gel material (e.g., reacting monomers together in the presence of a solvent resulting in the formation of a sol and subsequently a gel, or preparing a sol by dispersing prefabricated nanostructures and inducing them to gel by physical means or chemical adhesion) and introducing an organic solvent having a surface tension of less than 20 dynes/cm within pores of the gel material where the organic solvent includes fluorine. This step may involve exchanging or otherwise replacing a fluid already located within pores of the gel material with the organic solvent. The method may further involve evaporating the organic solvent from the pores of the gel material to produce an aerogel material.

In another illustrative embodiment, a method for manufacturing aerogels is provided. The method includes providing a gel material having a low-surface-tension solvent located within pores of the gel material and evaporating the solvent at ambient conditions to remove the solvent from the pores of the gel material to produce an aerogel material.

In yet another illustrative embodiment, a method for manufacturing an aerogel is provided. The aerogel may have at least one dimension greater than or equal to about 30 cm, a second dimension greater than or equal to about 1 cm, a compressive modulus greater than or equal to about 300 kPa, a compressive yield strength greater than or equal to about 20 kPa, and/or dimensions within about 20% of the its gel precursor's dimensions immediately prior to removal of the gel's pore fluid. The method may include providing a gel material having a low-surface-tension solvent and evaporating the solvent at about atmospheric pressure to produce an aerogel material.

In another illustrative embodiment, a method for manufacturing an aerogel is provided. The aerogel may have at least one dimension greater than or equal to about 4 cm, a second dimension greater than or equal to about 0.5 cm, a compressive modulus greater than or equal to about 300 kPa, a compressive yield strength greater than or equal to about 20 kPa and/or dimensions within about 20% of the its gel precursor's dimensions immediately prior to removal of the gel's pore fluid. The method may include providing a gel material having a low-surface-tension solvent and evaporating the solvent at about atmospheric pressure to produce an aerogel material.

In an illustrative embodiment, a method for manufacturing an aerogel is provided. The method includes displacing the pore fluid in a gel with a low-surface-tension fluorinated organic solvent and evaporating the solvent to produce an aerogel material.

Advantages, novel features, and objects of the present disclosure will become apparent from the following detailed description of the present disclosure when considered in conjunction with the accompanying drawings, which are schematic and which are not intended to be drawn to scale. For purposes of clarity, not every component is labeled in every figure, nor is every component of each embodiment of the present disclosure shown where illustration is not necessary to allow those of ordinary skill in the art to understand the present disclosure.

### BRIEF DESCRIPTION OF THE DRAWINGS

Various embodiments of the present disclosure will now be described, by way of example, with reference to the accompanying figures, in which:

FIG. 1 depicts a schematic representation of a gel during drying in accordance with some embodiments;

FIG. 2 depicts a schematic of a system for continuously drying gels in accordance with some embodiments;

FIG. 3 depicts a schematic of system for additively manufacturing aerogel by extruding aerogel precursor through a nozzle in accordance with some embodiments;

FIG. 4 depicts a schematic of a system for drying gels in accordance with some embodiments;

FIG. 5 depicts a schematic of a system for making aerogels with a photocurable compound (e.g., resin) and a fluorinated organic solvent in accordance with some embodiments; and

FIG. 6 depicts a schematic of a system for purifying and recycling fluorinated organic solvents from other components in some embodiments.

### DETAILED DESCRIPTION

The inventors have appreciated that it would be advantageous to be able to produce aerogel materials as relatively large monoliths (e.g., large, long panels) or as continuous blankets or thin films. In some embodiments, such aerogel materials may be manufactured without requiring a step of supercritical drying. Hence, as supercritical drying typically involves conditions provided by a heavy-wall pressure vessel, for certain embodiments according to the present disclosure, use of such a pressure vessel is not required.

In some embodiments, a gel may include a porous backbone structure and a solvent dispersed throughout the pores. The backbone may comprise any suitable material including, for example, polyurea, polyurethane, polyamide, polyimide, polyether, polyester, polymethylpentene, polyethylene, polymethylmethacrylate, polypropylene, polycarbonate, phenolic polymer, resorcinol-formaldehyde, acid-catalyzed resorcinol-formaldehyde, an acetic acid polymer, polybenzoxazine, silica-pectin polymer, polymer-crosslinked oxides, silica, metal/metalloid oxide, an ormosil, a silica-polymer hybrid, a polysaccharide, polysaccharides, amongst others. The solvent, or pore fluid, may be exchanged with another solvent, in some cases, multiple times so as to reach a suitable level of purity. Alternatively the gel structure may be synthesized in a suitable solvent that will later be removed. The solvent may then be suitably evaporated with little to no capillary force, resulting in an aerogel. The solvent may be selected from a set of suitable solvents having a low surface tension, resulting in a reduced degree of capillary forces that may otherwise result via evaporation of traditional solvents such as methanol, ethanol, acetone, acetonitrile, pentane, hexane, heptane, or diethyl ether. For some cases, such capillary forces may be undesirable during solvent removal, in part, because the capillary forces may result in shrinkage, cracking, and/or mechanical failure of the overall aerogel monolith.

In some embodiments, evaporation of the solvent may occur at atmospheric or ambient conditions (e.g., with or without a stream of gas flowing along the surface of the gel), thus, not requiring the use of a pressure vessel to remove the solvent. Ambient conditions may include ambient pressure conditions and ambient temperature conditions including temperatures near room temperature, e.g., about 0-50° C. Those of ordinary skill in the art would understand that ambient pressure corresponds to the pressure of the ambient environment, within the normal variations caused by elevation and/or barometric pressure fluctuations in normal operations under various weather conditions and locations of installation. Ambient pressure conditions may be distinguished from gage pressure conditions, in which the pressure (e.g., in a vacuum chamber, pressure vessel, or other enclosure in which pressure can be controlled) is described in terms of pressure relative to the ambient pressure (e.g., from a pressure measurement from a gauge or sensor). Because such manufacturing processes in accordance with certain embodiments of the present disclosure do not require a pressure vessel, the size of the resulting aerogel is not limited by the size of a pressure vessel chamber. In some embodiments, evaporation of solvent from the gel may result in an aerogel material in a matter of hours or minutes. Because such manufacturing processes in accordance with certain embodiments of the present disclosure are relatively fast, aerogel materials such as boards, panels, blankets, and thin films may be manufactured in a continuous fashion as opposed to a batch fashion as typically imposed when supercritical drying or freeze drying. Depending on the type of solvent that is evaporated from the gel, such aerogel manufacture may also occur without risk of flammability or combustion.

Generally speaking, aerogels are dry, nanoporous, nanostructured materials that exhibit a diverse array of extreme and valuable materials properties, e.g., low density, ultralow thermal conductivity, high density-normalized strength and stiffness, and high specific internal surface area, amongst others. The term aerogel may refer to a substance having a certain material composition that exhibits a particular geometry. Suitable aerogel material compositions may include, for example, silica, metal and metalloid oxides, metal chalcogenides, metals and metalloids, organic polymers, biopolymers, amorphous carbon, graphitic carbon, diamond, and discrete nanoscale objects such as carbon nanotubes, boron nitride nanotubes, viruses, semiconducting quantum dots, graphene, two-dimensional boron nitride, or combinations thereof.

Additionally, a number of aerogel nanocomposite configurations may be prepared, for instance, materials that integrate organic polymers and silica into a single network (e.g., ormosils, organically modified silica/silicate materials, etc.), materials in which two or more separate networks of different composition are interpenetrating (e.g., a metal oxide network interpenetrated with a resorcinol-formaldehyde polymer network), core-shell nanocomposites in which a polymer conformally coats the interior contour surfaces of an oxide network (e.g., x-aerogels, cross-linked aerogels, etc.), aerogels in which nanoparticles of a varying composition are dispersed (e.g., metal-nanoparticle-doped carbon aerogels, gold-nanoparticle-doped silica aerogels), and more. As provided herein, aerogel materials may be considered as any solid-phase material that is primarily mesoporous (i.e., contains pores between 2-50 nm in diameter), comprising at least a 50% void space by volume in which the solid-phase component comprises a 3D nanostructured solid network. Materials with pore sizes outside of 2-50 nm, e.g., <1-100 nm, <1 nm to less than about one micron, are also often considered aerogels. Accordingly, any material that meets this description may be considered as an aerogel material.

A number of potential applications of aerogel materials involve the materials being in monolithic or panel form, for example, as opposed to particles, powders, or fiber-reinforced blankets. Manufacturing of aerogel monoliths/panels with dimensions large enough to be useful for various applications (e.g., applications in aviation, automotive, marine, construction, etc.) using supercritical drying is often cumbersome and expensive, in large part, due to the following requirements: 1) large, expensive, specialized equipment, 2) size-limited throughput-stifling batch processes, and 3) copious amounts of carbon dioxide and/or flammable solvents and energy.

A number of potential applications of aerogel materials benefit from blanket-form materials (e.g., fiber-reinforced blanket-form materials); however current aerogel blanket materials often shed particles and generate nuisance dust. Similarly, a number of potential applications of aerogel materials would benefit from thin-film-form materials; however few approaches exist for making viable thin-film aerogel materials, in some cases due to low tensile strength. While certain manufacturing of blankets and thin films may be done using size-limiting throughput-stifling batch processes such as supercritical drying and freeze drying, such methods may undesirably require copious amounts of carbon dioxide and/or flammable solvents and energy.

Depending on composition, aerogel materials may exhibit certain properties, such as transparency, high-temperature stability, hydrophobicity, electrical conductivity, and/or non-flammability. Such properties may make aerogel materials desirable for various applications.

In general, aerogel materials may be made from precursors, such as gels. As provided herein, a gel may be a colloidal system in which a nanoporous, nanostructured solid network spans the volume occupied by a liquid medium. Accordingly, gels may have two components: a sponge-like solid skeleton that gives the gel its solid-like cohesiveness, and liquid that permeates the pores of that skeleton.

Gels of different compositions may be synthesized through a number of methods, which may include a sol-gel process. The sol-gel process involves the production of sol, or colloidal suspension of very small solid particles in a continuous liquid medium, where nanostructures (e.g., nanoparticles, nanotubes, nanoplatelettes, graphene, nanophase oligomers or polymer aggregates) form the solid particles dispersed in the liquid medium. The very small solid particles may be formed in situ or formed ex situ and dispersed in the liquid. The sol-gel process also involves causing the nanostructures in the sol to interconnect (e.g., through covalent or ionic bonding, polymerization, physisorption, or other mechanisms) to form a 3D network, forming a gel.

In the case of the production of a silica gel suitable for production of a silica aerogel, this can be accomplished by hydrolyzing a silicon alkoxide in the presence of a basic or acidic catalyst in a suitable volume of a solvent in which the water, silicon alkoxide, and catalyst are mutually soluble (such as an alcohol), which results in the formation of microporous (i.e., contains pores <2 nm in average diameter) silica nanoparticles dispersed in the liquid that subsequently interconnect into a contiguous mesoporous (i.e., contains average pore sizes of between 2-50 nm in diameter) network that spans the volume of the liquid.

Aerogels may be fabricated by removing the liquid from a gel in a way that preserves both the porosity and integrity of the gel's intricate nanostructured solid network. For most gel materials, if the liquid in the gel is evaporated, capillary stresses will arise as the vapor-liquid interface recedes into or from the gel, causing the gel's solid network to shrink or pull inwards on itself, and collapse. The resulting material is a dry, comparatively dense, low-porosity (generally <10% by volume) material that is often referred to as a xerogel material, or solid formed from the gel by drying with unhindered shrinkage. However, the liquid in the gel may be heated and pressurized past its critical point, a specific temperature and pressure at which the liquid will transform into a semi-liquid/semi-gas, or supercritical fluid, that exhibits little surface tension, if at all. Below the critical point, the liquid is in equilibrium with a vapor phase. As the system is heated and pressurized towards its critical point, molecules in the liquid develop an increasing amount of kinetic energy, moving past each other at an increasing rate until eventually their kinetic energy exceeds the intermolecular adhesion forces that give the liquid its cohesion. Simultaneously, the pressure in the vapor also increases, bringing molecules on average closer together until the density of the vapor becomes nearly and/or substantially as dense as the liquid phase. As the system reaches the critical point, the liquid and vapor phases become substantially indistinguishable and merge into a single phase that exhibits a density and thermal conductivity comparable to a liquid, yet is also able to expand and compress in a manner similar to that of a gas. Although technically a gas, the term supercritical fluid may refer to fluids near and/or past their critical point as such fluids, due to their density and kinetic energy, exhibit liquid-like properties that are not typically exhibited by ideal gases, for example, the ability to dissolve other substances. Since phase boundaries do not typically exist past the critical point, a supercritical fluid exhibits no surface tension and thus exerts no capillary forces, and can be removed from a gel without causing the gel's solid skeleton to collapse by isothermal depressurization of the fluid. After fluid removal, the resulting dry, low-density, high-porosity material is an aerogel.

The critical point of most substances typically lies at relatively high temperatures and pressures, thus, supercritical drying generally involves heating gels to elevated temperatures and pressures and hence is performed in a pressure vessel. For example, if a gel contains ethanol as its pore fluid, the ethanol can be supercritically extracted from the gel by placing the gel in a pressure vessel containing additional ethanol, slowly heating the vessel past the critical temperature of ethanol (241° C.), and allowing the autogenic vapor pressure of the ethanol to pressurize the system past the critical pressure of ethanol (60.6 atm). At these conditions, the vessel can then be quasi-isothermally depressurized so that the ethanol diffuses out of the pores of the gel without recondensing into a liquid. Likewise, if a gel contains a different solvent in its pores, the vessel may be heated and pressurized past the critical point of that solvent.

Most organic solvents used to make gels are dangerously flammable and potentially explosive at their critical points, hence, it may be desirable to first exchange the pore fluid of the gel with a safer, non-flammable solvent that can be supercritically extracted instead. For example, liquid carbon dioxide may be used as a substitute for organic solvents to supercritically dry aerogels. Carbon dioxide has the advantages of being miscible with many organic solvents, being non-flammable, and having a relatively low (31.1° C., 72.8 atm) critical point. Since carbon dioxide does not exist in liquid form at ambient conditions, solvent exchange of a gel's pore fluid with liquid carbon dioxide may be done by placing the gel inside a pressure vessel, pressurizing the vessel to the vapor pressure of carbon dioxide, and then siphoning or pumping liquid carbon dioxide into the vessel. Once the original pore fluid of the gel has been adequately replaced by liquid carbon dioxide, the gel may be heated and pressurized past the critical point of carbon dioxide and the carbon dioxide may be supercritically extracted by isothermal depressurization. Supercritical carbon dioxide may also be flowed over a gel to remove solvent from its pores.

In practice, sequential diffusive exchanges with liquid carbon dioxide can remove most, but not all, of the original organic solvent from the pores of the gel. Accordingly, the resulting carbon-dioxide-rich mixture will have a small mass fraction of organic solvent in it and accordingly a mass-fraction-dependent critical point that is higher than that of pure carbon dioxide. As a result, conservatively higher process temperatures and pressures may be used when supercritically drying with carbon dioxide in order to ensure sufficient removal of the pore fluid from the gel and to speed diffusion of fluid out of the tortuous nanoporous network of the gel. Because supercritical drying typically involves relatively high pressures, heavy-wall (usually stainless steel or another corrosion-resistant alloy) pressure vessels may be used to contain the process fluid and gel precursor materials. Accordingly, the dimensions of a monolithic aerogel (that is, solid continuous shaped form as opposed to particles or rolled fiber-reinforced composite blanket) made by supercritical drying are limited to the inner dimensions of the supercritical dryer equipment used to make it. Similarly the dimensions of a rolled fiber-reinforced composite blanket are limited to the inner dimensions of the supercritical drying equipment used to make it. Additionally, as noted above, supercritical drying often requires copious amounts of carbon dioxide and energy, solvent recycling, and substantial infrastructure, which can be time consuming and costly.

The present disclosure addresses the concerns raised above in providing materials and methods for making aerogels that avoid supercritical drying. Since capillary stresses are the source of collapse when the solvent in a gel is evaporated, carefully balancing the modulus of the gel backbone against the magnitude of capillary stress incurred in principle would allow for solvent to be removed from a gel without causing substantial collapse. Additionally, when a gel shrinks from capillary collapse, for many gel formulations, functional groups lining the struts of the gel backbone (e.g., often hydroxyl or other polar groups) may have a tendency to stick to each other by hydrogen bonding and/or may react to form a covalent bond (e.g., in the case of hydroxyls to form an oxygen bridge by water condensation, in the case of isocyanates to form a urea, uretdione, biruet, urethane, or other bond), causing irreversible shrinkage of the gel material.

In the case of a silica gel, hydroxyl groups may line the backbone of the gel. Since collapse due to capillary stresses is a response of the solid-phase material to the liquid-vapor interface receding into the overall material, such capillary stress during drying may be reduced by a number of ways. For instance, the pore fluid in the gel may be replaced with a low-surface-tension solvent (e.g., pentane, hexane, heptane, etc.) that will exert a minimal or otherwise reduced amount of capillary force on the gel backbone as the liquid-vapor interface recedes into the gel. Simultaneously, to prevent irreversible collapse of the gel backbone, surface groups lining the gel's backbone may be replaced with sterically-hindered, hydrophobic functional groups so that the struts of the gel do not stick to each other when the gel shrinks. In the case of silica, surface hydroxyl groups may be reacted with a hydrophobe such as trimethylchlorosilane, hexamethyldisilazane, or hexamethyldisiloxane to make sterically-hindering, hydrophobic trimethylsiloxy groups. The combination of the above techniques may significantly reduce or minimize shrinkage upon evaporation of solvent, and may permit reversal of shrinkage that does happen to occur, allowing for subcritical, ambient-pressure drying of aerogels.

Subcritical drying from traditional solvents such as methanol, ethanol, acetone, acetonitrile, pentane, hexane, heptane, diethyl ether, or hexamethyldisiloxane may have a tendency to result in shrinkage and cracking of gels, often limiting the technique to particles and small monoliths, or may be flammable in nature. Also, while subcritical drying may work well for some silica aerogel materials, in some cases, subcritical drying may be difficult to employ for other compositions. For aerogels with very high moduli, for example mechanically strong organic aerogels and x-aerogels, subcritical drying from low-surface-tension solvents such as pentane may result in shrinkage and cracking of monoliths, and may further involve dangerous quantities of flammable, high-vapor-pressure solvents. Also, subcritical drying may result in some permanent deformation even after reversal of shrinkage, meaning the resulting materials may tend to have lower porosity (e.g., 10-20% less porosity, for silica, <80-90% vs. 90-99.9+%), lower internal surface area, and higher density.

Analogous to how supercritical drying substantially limits the formation of phase boundaries by circumnavigating the critical point of a fluid, freeze drying (or lyophilization) may have the tendency to substantially limit phase boundary formation during drying by circumnavigating the triple point of a fluid, the temperature and pressure at which the solid, liquid, and vapor phases of a substance are able to coexist in equilibrium. In freeze drying, the liquid in a porous material may be removed by first freezing, and then sublimating the frozen solid away. In some cases, freeze drying may be used as a method of drying gels to produce cryogels. Additionally, freeze casting, in which a slurry of a solvent and discrete particles is molded and then freeze dried to produce an aerogel or aerogel-like material, may be used to make aerogels or aerogel-like materials having a number of different compositions, including alumina aerogels and graphene aerogels. In some cases, aerogels, such as oxide aerogels, may be produced through freeze drying to produce small particles or powders. The production of monoliths by freeze drying is challenging and tends to result in small particles or powders and may be due to the relative intolerance of low-strength oxide gels to the stresses induced by freeze drying (e.g., freeze drying from water), which may limit the production of large monolithic aerogels of such compositions. Additionally, freeze drying and freeze casting often result in materials with weakened mechanical properties and substantial macroporous character. While freeze drying may not involve high temperatures and pressures, freeze drying of aerogels, previously done exclusively under vacuum conditions, has required specialized equipment (e.g., vacuum chamber), that undermine key benefits of avoiding supercritical drying, such as not needing expensive pressure vessels and not limiting part dimensions to the size of the pressure vessel.

Much commercial focus of aerogels has been on silica aerogels, at least in part, due to their ultralow thermal conductivities (in some cases <20 mW/m-K), which makes them valuable for thermal insulation applications, and, to a lesser extent, their transparency, which makes them valuable in energy-efficient fenestration applications such as daylighting panels (i.e., skylights).

In addition, some commercial focus has been on carbon aerogels. For example, electrically-conductive carbon aerogels may be used as electrodes for supercapacitors, at least in part, due to their high internal surface area.

Another advantageous material property of aerogels is their high density-normalized strength and stiffness, which may be useful for applications demanding large parts and mechanical integrity such as lightweight plastics replacements, machinable parts for automotive, aerospace, and consumer electronics applications, and structural superinsulating panels for construction.

As discussed herein, conventional methods of producing aerogels without a supercritical dryer have generally been limited to very small monoliths (e.g., less than a few centimeters maximum dimension), particles, and powders, and/or may still result in substantial shrinkage of and/or microstructural damage to the overall material. Additionally, conventional methods of producing aerogels without a supercritical dryer have not enabled large aerogel panels with mechanical properties and durability demanded by applications such as automotive parts, aerospace structures, consumer electronics, and construction.

The inventors have recognized that evaporative drying of certain gel and gel-like materials with certain types of solvents allows for the production of aerogel materials without requiring a pressure vessel. Thus, the dimensions of such aerogel materials are not limited by confines that would otherwise be present if a pressure vessel is employed.

Solvents employed to produce aerogels in accordance with the present disclosure may also be non-flammable in nature.

Methods in accordance with the present disclosure provide for production of monolithic, large-dimension (i.e., centimeters to meters) aerogel materials, rapid drying of aerogels from gel and gel-like precursors, continuous production of continuous monolithic, roll, and thin-film aerogel materials, and additive manufacturing of complex 3D parts made of aerogel materials.

Specifically, solvents with low surface tension at room temperature and atmospheric pressure may be particularly well-suited. For example, fluorinated organic solvents with a surface tension of less than about 20 dynes/cm (e.g., approximately 20 dynes/cm), less than about 15 dynes/cm (e.g., approximately 15 dynes/cm), less than about 13 dynes/cm (e.g., approximately 13 dynes/cm), less than about 10 dynes/cm (e.g., approximately 10 dynes/cm), or surface tensions falling outside of the above noted ranges may be particularly suited. In some embodiments, the solvent comprises a carbon atom, a fluorine atom, and an oxygen atom. In some embodiments, Novec™ brand solvents obtainable from 3M® may be particularly well-suited. In some preferred embodiments, the solvent comprises 1-methoxyheptafluoropropane (e.g., Novec 7000), methoxynonafluorobutane (e.g., Novec 7100), ethoxynonafluorobutane (e.g., Novec 7200), 3-methoxy-4-trifluoromethyldecafluoropentane (e.g., Novec 7300), 2-trifluoromethyl-3-ethoxydodecafluorohexane (e.g., Novec 7500), 1,1,1,2,3,3-hexafluoro-4-(1,1,2,3,3,3-hexafluoropropoxy)-pentane (e.g., Novec 7600), 2,3,3,4,4-pentafluorotetrahydro-5-methoxy-2,5-bis[1,2,2,2-tetrafluoro-1-(trifluoromethyl)ethyl]-furan (Novec 7700), a fluorinated ketone such as CF₃CF₂C(═O)CF(CF₃)₂ dodecafluoro-2-methylpentan-3-one (e.g., Novec 1230/649), tetradecafluoro-2-methylhexan-3-one/tetradecafluoro-2,4-dimethylpentan-3-one (e.g., Novec 774), a fluorinated ether, tetradecafluorohexane/perfluoropentane/perfluorobutane (e.g., Fluorinert FC-72), a fluorinated hydrocarbon such as 2,3-dihydrodecafluoropentane (e.g., Vertrel® XF), or any other appropriate organic solvent that includes fluorine. According to certain but not necessarily all embodiments, the use of methoxynonafluorobutane (e.g., Novec 7100), ethoxynonafluorobutane (e.g., Novec 7200) can be particularly advantageous.

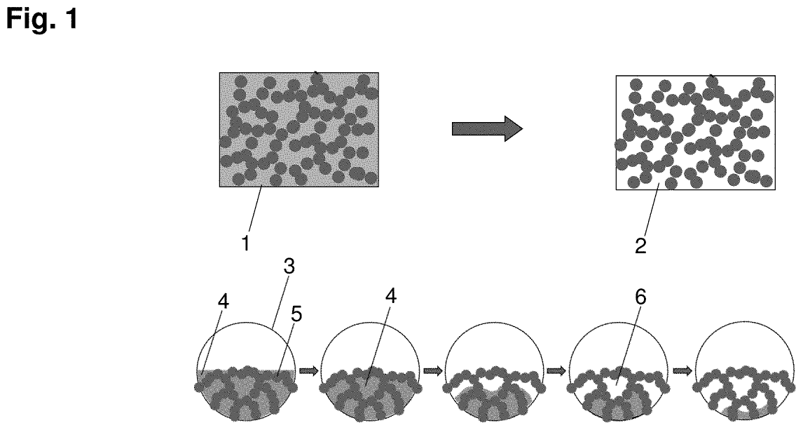

FIG. 1 depicts evaporative drying of a gel to make an aerogel in accordance with some embodiments. A wet gel 1 is evaporatively dried to make an aerogel 2. Wet gel 1 magnified in 3 comprises a pore fluid 4 and solid skeleton 5. As solvent is evaporated from the pore network, dry mesopores 6 result, resulting in a porous solid 2.

In some preferred embodiments, as discussed above, the solvent is substantially non-flammable and, in some embodiments, has substantially no flash point. Liquids may be considered substantially non-flammable if they do not meet OSHA general industry standard definition of a flammable liquid as defined at 29 CFR 1910.106(a)(19). 29 CFR 1910.106(a)(19) defines a flammable liquid as “[A]ny liquid having a flashpoint below 100° F. (37.8° C.), except any mixture having components with flashpoints of 100° F. (37.8° C.) or higher, the total of which make up 99 percent or more of the total volume of the mixture.” For example, Novec fluids have no flashpoint and therefore do not meet the definition of a flammable liquid, and may be considered substantially non-flammable. In some preferred embodiments, the solvent may be miscible with other organic solvents, such as methanol, ethanol, propanol, isopropanol, butanol, sec-butanol, tert-butanol, pentanol, neopentanol, amyl alcohol, acetone, methyl ethyl ketone, acetonitrile, N-methylpyrrolidone, dimethylacetamide, N,N′-dimethylformamide, dimethylsulfoxide, ethyl acetate, amyl acetate, cyclohexanol, cyclohexane, pentane, hexane, heptane, alcohols, ketones, pyrrolidones, or other appropriate solvents. In some preferred embodiments, the solvent may be miscible with methanol. In some preferred embodiments, the solvent may be miscible with acetone. In some preferred embodiments, the solvent may be miscible with N-methylpyrrolidone. In some embodiments, the solvent has a boiling point of approximately room temperature (e.g., 25° C.), greater than approximately 30° C., greater than approximately 40° C., greater than approximately 50° C., greater than approximately 60° C., greater than approximately 70° C., greater than approximately 80° C., or greater than approximately 100° C. Those of ordinary skill in the art would understand room temperature to be the temperature of the environment in which the fluid is used. In some embodiments, room temperature can be between about 20° C. and about 25° C.

In some embodiments, the fluorinated organic solvent has a low ozone depletion potential or a low global warming potential, where the ozone depletion potential and global warming potential are determined according to methods known by those of ordinary skill in the art. Ozone depletion potential and global warming potential are known to those of ordinary skill in the art and are given for many materials in their technical data sheets. In some preferred embodiments, the fluorinated organic solvent has an ozone depletion potential less than 10, less than 5, less than 1. In some preferred embodiments, the fluorinated organic solvent has a global warming potential of less than 10,000, less than 5,000, less than 1,000, less than 500, less than 50. For example, ethoxynonafluorobutane may have an ozone depletion potential of 0.0, and a global warming potential of 55. Dodecafluoro-2-methylpentan-3-one may have an ozone depletion potential of 0.0, and a global warming potential of 1.

In accordance with embodiments of the present disclosure, certain combinations of material compositions, solvent preparation steps, pore fluid exchange steps, and solvent evaporation steps may provide for the production of large (i.e., ranging from centimeters to several meters) monolithic panels and rolls of aerogel materials (and other porous materials) with thermal insulating, acoustic damping, high-surface-area, weight-saving, and machinability benefits without requiring supercritical drying or freeze drying. These processes are advantageous as they leverage and integrate, for the first time, a number of key insights regarding the nature of aerogels and drying of porous materials to enable dimensional scaling of aerogels and preservation of materials properties in ways that have previously not been attainable without supercritical drying or solvents having flammable characteristics.

Such processes also provide several benefits over supercritical drying including eliminating size limitations and reducing manufacturing and infrastructure costs.

In some embodiments, a gel material is synthesized by any of a number of well-established methods, known in the art. The gel material can then be subject to solvent exchange with a fluorinated organic solvent by placing the gel material in a bath containing the fluorinated organic solvent and allowing the fluorinated solvent to diffusively displace the existing pore fluid in the gel material. In some embodiments, the gel material is free of water or contains water in an amount of no more than about 0.01 v/v %, no more than about 0.1 v/v %, no more than about 0.5 v/v %, or no more than about 1.0 v/v % when the organic solvent contacts the gel material. In some embodiments, a volume of fluorinated organic solvent in excess of the volume of the gel material may be used. In some preferred embodiments, the volume of the fluorinated organic solvent is at least three times, at least five times, at least fifteen times, at least twenty-five times the volume of the gel material. In some embodiments, a fluorinated organic solvent is flowed over the gel material. In some preferred embodiments, the existing solvent located within the pores of the gel is exchanged for a fluorinated organic solvent until the purity of the fluorinated organic solvent in the gel is within 5 v/v %, within 1 v/v %, within 0.5 v/v %, within 0.1 v/v %, within 0.05 v/v %, within 0.01 v/v %, within 0.005 v/v %, within 0.001 v/v %, within 0.0005 v/v %, within 0.0001 v/v % of the purity of the original fluorinated organic solvent.

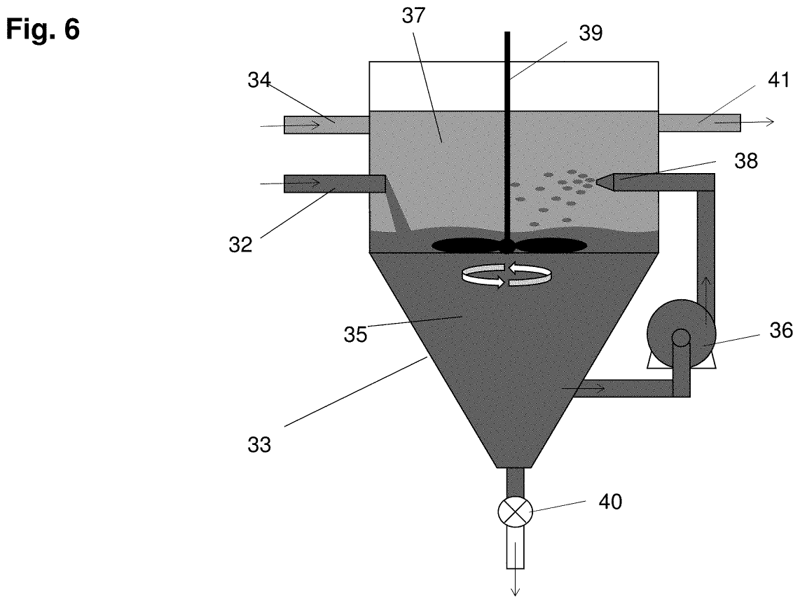

After exchanging the pore fluid of a gel with a fluorinated organic solvent, the used fluorinated organic solvent may be contaminated (e.g., with the original solvent removed from the gel). Generally, when referring to “contaminants” in this context, the contaminants are parts of the gel (e.g., the solvent initially present in the gel prior to solvent exchange and/or other materials within the gel) that are transferred into the fluorinated organic solvent during the solvent exchange step. To reduce the costs of manufacturing of aerogels in some embodiments, it may be advantageous to purify and recycle the contaminated fluorinated organic solvent. In some embodiments, separating fluorinated organic solvents from contaminants via distillation may be energy-intensive and costly, particularly since in certain embodiments mixtures of fluorinated organic solvents and solvents used in gel pore fluids form azeotropic mixtures. The inventors have developed a method, according to certain embodiments, for separating some solvents from fluorinated organic solvents, for example, to allow for recycle and reuse of the fluorinated organic solvent. In some embodiments, the fluorinated organic solvent has essentially zero miscibility with water. In certain embodiments in which the contaminant pore fluid solvent is both miscible with the fluorinated organic solvent and water, the contaminant solvent can be extracted by water while still remaining in a distinct phase from the fluorinated organic solvent. In some embodiments, water may remove at least a portion or all of the contaminants from the fluorinated organic solvent. The effectiveness of water at removing contaminants from fluorinated organic solvents, according to certain embodiments, is surprising and far in excess of what would be expected by simple distribution of the contaminant evenly between the water phase and the fluorinated organic solvent phase. In some embodiments the fluorinated organic solvent contains less than about 5 v/v % impurities, less than about 1 v/v % impurities, less than about 0.1 v/v % impurities, or less than about 0.01 v/v % impurities after contaminants have been removed from the fluorinated organic solvent by water. By this method, in some embodiments, water can be used to effectively extract a contaminant solvent from the fluorinated organic solvent much more efficiently than distillation. The purified fluorinated organic solvent may then be reused in the production of a gel or aerogel, according to certain embodiments. This process is outlined, in one particular embodiment, in Example 24 and is shown in FIG. 6.

FIG. 6 depicts a method wherein fluorinated organic solvents, which in some embodiments are insoluble in water, are separated from water-miscible non-fluorinated contaminant solvents. One of ordinary skill in the art would be able to recognize the difference between soluble and insoluble solvents. For example, a first solvent may be considered insoluble in a second solvent if less than about 0.1 v/v % of the first solvent may be dissolved in the second solvent. Referring to FIG. 6, contaminated fluorinated solvents 32 can be added to a separatory funnel 33. Deionized water can be added to the funnel via port 34. The fluorinated solvent phase 35 can be circulated with a pump 36 into the less dense water phase 37 and dispersed by a nozzle 38. Additional phase mixing can be achieved by a mixer 39. The effluent stream 40 can be removed (e.g., after about one hour) and can contain purified (e.g., to any of the degrees mentioned above or elsewhere herein) fluorinated organic solvent. The water phase, now comprising deionized water and contaminant solvents that were separated from the fluorinated solvent, can be removed through port 41.

In some embodiments, the solvent is exchanged with the assistance of an applied pressure. In some embodiments, such application of pressure increases the rate of solvent exchange between solvents. For example, a gel material may be placed in a bath of the desired target solvent, e.g., a fluorinated organic solvent, over which a pressure is applied. The pressure may be applied hydrostatically, e.g., with a piston, or applied with a pressurized gas, e.g., with pressurized air, nitrogen, argon, carbon dioxide, or other gas. In some embodiments, a pressure of approximately 10 psi or greater (e.g., between 10-50 psi) may be applied. In some embodiments, a pressure of greater than 50 psi (e.g., between 50-100 psi) may be applied. In some embodiments, a pressure of approximately 80 psi or greater (e.g., between 80-150 psi) may be applied. In some embodiments, a pressure of approximately 100 psi or greater (e.g., between 100-200 psi) may be applied. Other lower and higher pressures may be suitable.

In some embodiments, the fluorinated organic solvent evaporates or is otherwise removed from the gel by simply exposing the gel to ambient atmosphere. In some embodiments, the fluorinated organic solvent is removed under a flow of gas. In some preferred embodiments, the gas is substantially dry. In some embodiments, the gas comprises dry air. In some embodiments, the gas comprises nitrogen. In some embodiments, the gas comprises carbon dioxide. In some embodiments, the flow rate of the gas is at least 10, at least 100, at least 1000, or at least 10000 standard liters per minute (SLM) per square meter of exposed gel envelope surface area. In some embodiments, the fluorinated organic solvent is removed at a rate of at least 10, at least 50, at least 100, at least 150, at least 200, at least 500, or at least 1000 grams per hour per square meter of exposed gel envelope surface area. In some embodiments, the rate at which organic solvent is removed from the gel is independent of the length and width of the gel. In some embodiments, the rate at which fluorinated organic solvent is removed from the gel is a function of the gel thickness.

In some embodiments, a gel material having a thickness of approximately 1 cm may be evaporatively dried in as little as about 10 min, about 20 min, about 30 min, about 1 hour, about 2 hours, about 5 hours. In some embodiments, slower evaporation of solvent may facilitate production of lower density materials. For example, in some embodiments, a gel that yields an aerogel with a density of 0.1 g/cc by supercritical drying may be evaporatively dried (e.g., in ambient atmospheric conditions) at a temperature lower than room temperature and/or under dry atmosphere to minimize densification of the gel material upon drying, resulting in an aerogel material with a density within about 1%, 5%, 10%, 20%, 50% of the density that would arise if subject to supercritically drying.

In some embodiments, the gel is dried at a temperature of about 20° C., about 15° C., about 10° C., about 5° C., about 0° C., about −5° C., about −10° C., about −15° C., about −20° C., about −25° C., about −30° C. In certain embodiments, the gel is dried at a temperature within a range bound by any of these temperatures (e.g., from about −30° C. to about 20° C., from about −25° C. to about 20° C., etc.). In some embodiments, the gel is dried at a temperature within 5° C. of the freezing point of the pore fluid.

In some embodiments, removal of solvent at higher temperatures may facilitate production of lower density materials. For example, in some embodiments, the surface tension of the fluorinated organic solvent decreases with increasing temperature. In some embodiments, the gel is dried at a temperature within about 1° C., about 5° C., about 10° C., about 20° C., about 50° C. of the boiling point of the fluorinated organic solvent.

In some embodiments, a gel material is synthesized directly in a fluorinated organic solvent. That is, the fluorinated organic solvent may be employed as the initial solvent throughout which the gel is formed. For example, in some embodiments, monomers are added directly to the fluorinated organic solvent and react to form a gel material. The pore fluid in the gel material is then evaporated, producing an aerogel material. In some embodiments, prepolymerized monomers or oligomers are added to a fluorinated organic solvent. The prepolymerized monomers or oligomers may spontaneously polymerize, or may be polymerized by the addition of heat, a catalyst, light, or by other any suitable method, from which a gel material may result. The pore fluid in the gel material may then be evaporated, producing an aerogel material. In some embodiments, a fluorinated-solvent-containing gel material may be used as an injectable precursor to an aerogel that can be injected into a cavity, such as a wall, a refrigerator, or a mold. The fluorinated solvent spontaneously evaporates from the gel material leaving the three-dimensional porous network intact, resulting in the aerogel. Accordingly, for various embodiments, a fluorinated-solvent-containing gel material may be used to additively manufacture an aerogel material, for example, a 3D aerogel part. In some preferred embodiments, the additive manufacturing is 3D printing. In some embodiments, a fluorinated-solvent-containing gel material may be used to manufacture a monolithic panel, a blanket, or a thin film.

Certain embodiments are related to the production of aerogels that are not silica-based aerogels (e.g., aerogels that are not alkyl-modified silica and/or siloxane aerogels). Silica-based aerogels, (such as alkyl-modified silica and/or siloxane aerogels) are generally extremely brittle and are generally impractical for most commercial applications that would benefit from the materials properties of aerogels. These properties furthermore make production of aerogel panels with meter-scale dimensions impractical and prohibitively expensive. Production of silica-based aerogels with fluorinated organic solvents also generally relies on functionalization of the gel backbone, which natively expresses hydroxyl groups, to prevent collapse of the silica-based gel during drying. For example, hydroxyl groups lining the silica backbone may result in irreversible shrinkage of silica-based gels even when dried from low-surface-tension solvents such as fluorinated organic solvents. By replacing these hydroxyl groups with sterically-hindered hydrophobic groups, such as alkyl groups, the struts of the backbone may no longer stick to each other upon shrinkage of the gel, enabling shrinkage of the gel to be reversed. Additionally, silica-based gels may have a high tendency to shrink and crack from evaporative drying even once functionalized. In many cases in which silica-based gels are used, the drying rate may need to be carefully controlled to prevent cracking, and even then, careful control may not be enough to prevent cracking of all silica-based gel materials.

The inventors have identified, according to certain embodiments, specific aerogel compositions with mechanical properties suitable for commercial applications (e.g., high compressive modulus, high yield strength, and/or high fracture toughness) which may be particularly advantageous for use in some (but not necessarily all) cases. Such aerogel compositions may include, for example, organic polymer aerogels and polymer-reinforced inorganic oxide aerogels, e.g., x-aerogels or polymer-crosslinked aerogels. However, evaporative drying of gel precursors suitable for making such aerogels by supercritical drying may result in substantial shrinkage and densification of the gels, resulting in materials that are not aerogels or have low porosity and do not have desirable materials properties. Unlike silica-based gels, polymer gels, such as those comprising polyurea, polyimide, polyurethane, and/or polyamide, are not generally lined with hydroxyl groups or other exposed reactive functional groups that may be functionalized to make the gel backbone resistant to irreversible shrinkage during evaporative drying. Rather, the functional groups that result in stiction of the struts of the gel are intrinsic to the polymer structure, e.g., urea, imide, urethane, and amide groups. Other types of polymer gels may also be affected by stiction, for example, gels comprising polyacrylate, polystyrene, polybenzoxazine, polyethylene, and polynorbornene. Accordingly, previous techniques used to prepare silica gels for evaporative drying, e.g., reacting hydroxyl groups with a hydrophobe or incorporating alkyl-modified siloxanes into the silica backbone structure, are generally not suitable for evaporative drying of polymer aerogels and polymer-reinforced inorganic oxide aerogels.

Certain embodiments are related to the production of aerogels using solvents that are substantially non-flammable and/or that can be processed without cracking the aerogel. For example, processes in which polymer aerogels and polymer-reinforced inorganic oxide aerogels are prepared by evaporative drying from low-surface-tension solvents such as pentane, hexane, heptane, acetone, and acetonitrile frequently result in shrinkage and cracking of the aerogel parts and are generally not well-suited for large-scale production. Additionally, copious amounts of highly flammable solvents, such as pentane, are typically employed making production incredibly dangerous and expensive. Non-flammable fluorinated solvents are therefore, according to certain embodiments, interesting solvents for preparing aerogels, such as polymer aerogels and polymer-reinforced inorganic oxide aerogels.

Evaporative drying of fluorinated organic solvents from certain aerogels (e.g., organic polymer and polymer-reinforced inorganic oxide gels) further involves, according to certain embodiments, surprising, unexpected responses of the gels. Organic polymer gels are often synthesized in organic solvents such as methanol, acetone, and N-methylpyrrolidone. Accordingly, such gels often contain these solvents along with water and unreacted monomers, even after soaking the gels in baths of a pure target solvent, or solvent exchange, to purify the gels. Although fluorinated organic solvents exhibit low surface tensions that may minimize capillary stress upon evaporation of pore fluid from the gel network, diffusion of fluorinated organic solvents such as alkoxyfluoroalkanes into the pore network before evaporation of the pore fluid from the gel may cause many gel compositions to densify and/or crack. The inventors have appreciated, in accordance with certain embodiments, that many gel compositions (e.g., gels comprising polyurea, polyimide, polyurethane, and/or polyamide, among others) exhibit strong mechanical responses when exposed to fluorinated organic solvents. Without wishing to be bound by any particular theory, it is believed that shrinkage, warping, and/or cracking of such gel compositions may result due to one or more of the following: polar interactions between the pore fluid of the gel and fluorinated organic solvents, adsorption and intermolecular bonding of impurities not solubilized by fluorinated organic solvents to the gel backbone, temperature-dependent entropy of mixing effects that result in localized expansion and/or contraction of the mixture that results from intermixing of the pore fluid and fluorinated organic solvent, and mass-fraction-dependent entropy of mixing effects that result in localized expansion and/or contraction of the mixture that results from intermixing of the pore fluid and fluorinated organic solvent. It is believed that, together, these phenomena (or others) may have the effect of causing many gel compositions, such as polyurea, polyimide, polyurethane, polyamide, and polymer-reinforced inorganic oxide gels, to densify, warp, and/or crack when contacted by fluorinated solvents unless specific conditions are employed.

For at least the reasons described herein, it had not been previously appreciated that the use of fluorinated organic solvent solvents would enable production of many aerogel materials. Additionally, it had not been previously appreciated that large, monolithic, substantially crack-free aerogel panels, rolls, and thin films of many aerogel compositions could be produced using such solvents. Furthermore, it had not been previously appreciated what types of gel precursors could be dried from such solvents and what materials properties those gel precursors should have to afford monolithic, substantially crack-free aerogel materials. It had also not been previously appreciated under what conditions evaporation of fluorinated solvents could be performed, what purity the pore fluid of the gel must be, or how to replace the pore fluid of a gel with fluorinated solvents to facilitate production of monolithic, substantially crack-free aerogel materials of many compositions. It had also not been appreciated how evaporative drying of many aerogels could be done at ambient conditions without use of flammable solvents or vapors.

Accordingly, certain embodiments of the inventive processes described herein enable production of materials that were previously unable to be manufactured due to the limitations of existing methods, such as supercritical drying.

Porous materials that do not rigorously meet the general definition of aerogel proposed herein can also be made. For example, materials that primarily contain pores greater than 50 nm in diameter, even microns, can be made, e.g., acid-catalyzed resorcinol-formaldehyde polymer gels. Materials that are less than 50% porous may also be made, e.g., relatively dense porous polyurethane nanostructured networks. Porous materials that are not nanostructured may also be made, e.g., polymer foams. Non-monolithic materials, e.g., powders and fiber-reinforced blankets, may also be made. Accordingly, the methods herein are not limited specifically to aerogels or monolithic, substantially crack-free aerogels but are more widely applicable to porous materials of a wide variety as well.

Mechanically strong aerogel precursors may be particularly suited for drying by methods described herein. These including polymer-crosslinked oxides (the dried form of which are called cross-linked aerogels or x-aerogels, the wet form of which are called x-aerogel precursors or polymer-crosslinked gels), in which the interior contour surfaces of a network comprising metal oxide and/or metalloid oxide are coated with a polymer.

In some embodiments, this polymer coating is a conformal coating. In some embodiments, this coating comprises a covalent bond to the oxide. In some embodiments, this coating comprises one or more surface layers. In some embodiments, the polymer comprises a polymer derived from an isocyanate. In some embodiments, the polymer comprises a polymer derived from an epoxide. In some embodiments, the polymer comprises a polymer derived from an amine. In some embodiments, the polymer comprises a polymer derived from a carboxylic acid. In some embodiments, the polymer comprises a polymer derived from an alcohol, a polyol, or other similar substance. In some embodiments, the polymer comprises a polymer derived from a cyclopentadiene. In some embodiments, the polymer comprises a polymer derived from a polystyrene, a polyacrylate, a polyvinyl, a polyacrylonitrile. In some embodiments, the oxide network is functionalized with a reactive functional group on its skeleton. In some embodiments, the reactive functional group comprises a hydroxyl, an amine, an isocyanate, a carboxylic acid, an acid halide, an epoxide, an ester, a vinyl. In some embodiments, the reactive functional group comprises an alkyl chain, an aromatic group. In some embodiments, a functional group on the oxide network forms a bond with the polymer. In some embodiments, light is used to invoke polymerization of the crosslinking agent. In some embodiments, only the outer skins of the gel envelope are crosslinked.

In accordance with aspects of the present disclosure, suitable gel materials may be selected for evaporative drying with low-surface-tension solvents. The pore fluid in the gel may be exchanged for a suitable solvent. The pore fluid in the gel may then be degassed. The pore fluid in the gel may then be evaporated.

In some embodiments, suitable gel materials include gels comprising a polyurea, a polyurethane, a polyisocyanate, a polyisocyanurate, a polyimide, a polyamide, a polyacrylonitrile, a polycyclopentadiene, a polynorbornene, a polybenzoxazine, a polyacrylamide, a phenolic polymer, a resorcinol-formaldehyde polymer, a melamine-formaldehyde polymer, a resorcinol-melamine-formaldehyde polymer, a furfural-formaldehyde polymer, a resole, a novolac, an acetic-acid-based polymer, a polymer-crosslinked oxide, silica, a metal oxide, a metalloid oxide, a silica-polysaccharide polymer, a silica-pectin polymer, a polysaccharide, a glycoprotein, a proteoglycan, collagen, a protein, a polypeptide, a nucleic acid, amorphous carbon, graphitic carbon, a carbon nanotube, graphene, diamond, a boron nitride nanotube, two-dimensional boron nitride, an alginate, a chitin, a chitosan, a pectin, a gelatin, a gelan, a gum, an agarose, an agar, a cellulose, a virus, a biopolymer, an ormosil, an organic-inorganic hybrid material, a rubber, a polybutadiene, a poly(methyl pentene), a polyester, a polyether ether ketone, a polyether ketone ketone, a polypentene, a polybutene, a polytetrafluorethylene, a polyethylene, a polypropylene, a polyacrylate, a polystyrene, a polyketone, bisphenol-A resins, an epoxy resin, a hydrocarbon resin, a polyaldehyde-ketone resin, a polymethacrylate, a polyvinylacetate, a polyethylene terephthalate, a polyether, an alkyd resin, a metal nanoparticle, a metalloid nanoparticle, a metal chalcogenide, a metalloid chalcogenide, a carbonizable polymer. In some preferred embodiments, suitable gel materials may include gels comprising a polyurea, a polyamide, a polyurethane, a polyimide, and a polymer-crosslinked oxide.

In some embodiments, the polyurea of a gel is derived from the reaction of an isocyanate with water, in which amines are formed in situ. In some embodiments, the polyurea is derived from the reaction of an isocyanate with an amine.

In some embodiments, the polyurethane of a gel is formed with a catalyst such as DABCO, dibutyltin dilaurate, a polyurethane catalyst, a tin catalyst. In some embodiments, the polyurethane comprises an aromatic group. In some embodiments, the polyurethane exhibits a thermal conductivity less than about 20 mW/m-K.

In some embodiments, the polyimide of a gel is derived from the reaction of an amine with an anhydride. In some embodiments, the polyimide comprises an aromatic triamine. In some embodiments, a poly(amic acid) precursor is formed. In some embodiments, the polyimide comprises and inorganic crosslinker. In further embodiments, the inorganic crosslinker comprises a silicate, a silsesquioxane. In some embodiments, the polyimide is derived from the reaction of an isocyanate with an anhydride. In some embodiments, the isocyanate is a triisocyanate.

In some embodiments, an isocyanate is used to make the solid phase of a gel material. In some preferred embodiments, the isocyanate comprises hexamethylenediisocyanate, Desmodur® N3200, Desmodur N3300, Desmodur N100, Desmodur N3400, Desmodur RE, Desmodur RC, Mondur® MR, Mondur MRS, a methylene diphenyl diisocyanate, diphenylmethane 2,2′-, 2,4′- and/or 4,4′-diisocyanate (MDI), naphthylene 1,5-diisocyanate (NDI), a toluene diisocyanate, toluene 2,4- and/or 2,6-diisocyanate (TDI), 3,3′-dimethylbiphenyl diisocyanate, 1,2-diphenylethane diisocyanate and/or p-phenylene diisocyanate (PPDI), trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate.

In some embodiments, a silane is used to make the solid phase of a gel material. In some preferred embodiments, the silane comprises tetramethoxysilane, tetraethoxysilane, a tetraalkoxysilane, methyltrimethoxysilane, a trialkoxysilane, 3-aminopropyltriethoxysilane, 3-isocyanatopropyltriethoxysilane, a polysiloxane, a polydimethylsiloxane, a chlorosilane, dichlorodimethylsilane, trichloromethylsilane, dimethyldimethoxysilane, or another suitable silane.

In some embodiments, a catalyst is used to make the solid phase of a gel material. In some preferred embodiments, the catalyst is selected from the group consisting of primary, secondary, and tertiary amines; triazine derivatives; organometallic compounds; metal chelates; quaternary ammonium salts; ammonium hydroxides; and alkali metal and alkaline earth metal hydroxides, alkoxides and carboxylates.

In some embodiments, a tertiary amine is used as a gelling catalyst or trimerization catalyst. In some preferred embodiments, the tertiary amine comprises N,N-dimethylbenzylamine, N,N′-dimethylpiperazine, N,N-dimethylcyclohexylamine, N,N′,N″-tris(dialkylaminoalkyl)-s-hexahydrotriazines, for example N,N′,N″-tris(dimethylaminopropyl)-s-hexahydrotriazine, tris(dimethylaminomethyl)phenol, bis(2-dimethylaminoethyl) ether, N,N,N,N,N-pentamethyldiethylenetriamine, methylimidazole, dimethylimidazole, dimethylbenzylamine, 1,6-diazabicyclo[5.4.0]undec-7-ene (IUPAC: 1,4-diazabicyclo[2.2.2]octane), triethylamine, triethylenediamine, dimethylaminoethanolamine, dimethylaminopropylamine, N,N-dimethylaminoethoxyethanol, N,N,N-trimethylaminoethylethanolamine, triethanolamine, diethanolamine, triisopropanolamine and diisopropanolamine. In some embodiments, an organometallic compound is used as a gelling catalyst. In some preferred embodiments, the organometallic compound comprises tin 2-ethylhexanoate, dibutyltin dilaurate, a metal ion ethylhexanoate, zinc acetylacetonate, a metal acetoacetonate.

In some embodiments, a monomer that polymerizes by radical-mediated polymerization is used to make the solid phase of a gel. In some embodiments, the monomer comprises acrylonitrile, methyl(methacrylate), styrene, 1,3-divinylbenzene, 1,3,5-trivinylbenzene, or any suitable monomer that polymerizes by radical-mediated polymerization.

In some embodiments, a radical initiator is used to make the solid phase of a gel. In some embodiments, the radical initiator comprises azobisisobutyronitrile (AIBN), (4,4′-(diazene-1,2-diyl)bis-(4-cyano-N-(3-triethoxysilyl)propyl)pentanamide) (Si-AIBN), a peroxide initiator, an organic peroxide initiator, an azo initiator, a halogen initiator, or any suitable initiator compound.

In some embodiments, solvents used to make polyisocyanate materials are used to make a gel material. In some preferred embodiments, the solvent comprises a ketone, an aldehyde, an alkyl alkanoate, an amide such as formamide and N-methylpyrrolidone, a sulfoxide such as dimethyl sulfoxide, aliphatic halogenated hydrocarbons, cycloaliphatic halogenated hydrocarbons, halogenated aromatic compounds, and/or fluorinated ethers.

In some embodiments, an aldehyde and/or ketone solvent is used to make a gel material. In some preferred embodiments, the solvent comprises acetaldehyde, propionaldehyde, n-butyraldehyde, isobutyraldehyde, 2-ethylbutyraldehyde, valeraldehyde, isopentaldehyde, 2-methylpentaldehyde, 2-ethylhexaldehyde, acrolein, methacrolein, crotonaldehyde, furfural, acrolein dimer, methacrolein dimer, 1,2,3,6-tetrahydrobenzaldehyde, 6-methyl-3-cyclohexenealdehyde, cyanacetaldehyde, ethyl glyoxylate, benzaldehyde, acetone, diethyl ketone, methyl ethyl ketone, methyl isobutyl ketone, methyl n-butyl ketone, ethyl isopropyl ketone, 2-acetylfuran, 2-methoxy-4-methylpentan-2-one, cyclohexanone, and/or acetophenone.

In some embodiments, an alkyl alkanoate solvent is used to make a gel material. In some preferred embodiments, the solvent comprises methyl formate, methyl acetate, ethyl formate, butyl acetate, and/or ethyl acetate.

In some embodiments, an acetal solvent is used to make a gel material. In some preferred embodiments, the solvent comprises diethoxymethane, dimethoxymethane, and/or 1,3-dioxolane.

In some embodiments, a dialkyl ether, cyclic ether solvent is used to make a gel material. In some preferred embodiments, the solvent comprises methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl t-butyl ether, ethyl n-butyl ether, ethyl isobutyl ether and/or ethyl t-butyl ether. Preferred cyclic ethers are especially tetrahydrofuran, dioxane, and/or tetrahydropyran.

In some embodiments, a hydrocarbon solvent is used to make a gel material. In some preferred embodiments, the solvent comprises ethane, propane, n-butane, isobutane, n-pentane, isopentane, cyclopentane, neopentane, hexane, and/or cyclohexane.

In some embodiments, a fluorocarbon solvent is used to make a gel material. In some preferred embodiments, the solvent comprises difluoromethane, 1,2-difluoroethane, 1,1,1,4,4,4-hexafluorobutane, pentafluoroethane, 1,1,1,2-tetrafluoroethane, 1,1,2,2-tetrafluoroethane, pentafluorobutane and its isomers, tetrafluoropropane and its isomers, and/or pentafluoropropane and its isomers. Substantially fluorinated or perfluorinated (cyclo)alkanes having 2 to 10 carbon atoms can also be used.

In some embodiments, a chlorofluorocarbon solvent is used to make a gel material. In some preferred embodiments, the solvent comprises chlorodifluoromethane, 1,1-dichloro-2,2,2-trifluoroethane, 1,1-dichloro-1-fluoroethane, 1-chloro-1,1-difluoroethane, 1-chloro-2-fluoroethane, 1,1,1,2-tetrafluoro-2-chloroethane, trichlorofluoromethane, dichlorodifluoromethane, trichlorotrifluoroethane, tetrafluorodichloroethane, 1- and 2-chloropropane, dichloromethane, monochlorobenzene, and/or dichlorobenzene.

In some embodiments, a fluorine-containing ether solvent is used to make a gel material. In some preferred embodiments, the solvent comprises bis-(trifluoromethyl) ether, trifluoromethyl difluoromethyl ether, methyl fluoromethyl ether, methyl trifluoromethyl ether, bis-(difluoromethyl) ether, fluoromethyl difluoromethyl ether, methyl difluoromethyl ether, bis-(fluoromethyl) ether, 2,2,2-trifluoroethyl difluoromethyl ether, pentafluoroethyl trifluoromethyl ether, pentafluoroethyl difluoromethyl ether, 1,1,2,2-tetrafluoroethyl difluoromethyl ether, 1,2,2,2-tetrafluoroethyl fluoromethyl ether, 1,2,2-trifluoroethyl difluoromethyl ether, 1,1-difluoroethyl methyl ether, 1,1,1,3,3,3-hexafluoroprop-2-yl fluoromethyl ether.

In some embodiments, an amine is used to make the solid phase of a gel material. In some preferred embodiments, the amine comprises 4,4′-oxydianiline, 3,4′-oxydianiline, 3,3′-oxydianiline, p-phenylenediamine, m-phenylenediamine, o-phenylenediamine, diaminobenzanilide, 3,5-diaminobenzoic acid, 3,3′-diaminodiphenylsulfone, 4,4′-diaminodiphenyl sulfones, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl-]hexafluoropropane, 2,2-bis(3-aminophenyl)-1,1,1,3,3,3-hexafluoropropane, 4,4′-isopropylidenedianiline, 1-(4-aminophenoxy)-3-(3-aminophenoxy)benzene, 1-(4-aminophenoxy)-4-(3-aminophenoxy)benzene, bis [4-(4-aminophenoxy)phenyl] sulfones, 2,2-bis[4-(3-aminophenoxy)phenyl]sulfones, bis(4-[4-aminophenoxy]phenyl)ether, 2,2′-bis(4-aminophenyl)-hexafluoropropane, (6F-diamine), 2,2′-bis(4-phenoxyaniline)isopropylidene, m-phenylenediamine, p-phenylenediamine, 1,2-diaminobenzene, 4,4′-diaminodiphenylmethane, 2,2-bis(4-aminophenyl)propane, 4,4′diaminodiphenylpropane, 4,4′-diaminodiphenylsulfide, 4,4′-diaminodiphenylsulfone, 3,4′-diaminodiphenyl ether, 4,4′-diaminodiphenyl ether, 2,6-diaminopyridine, bis(3-aminopheny 1)diethyl silane, 4,4′-diaminodiphenyldiethyl silane, benzidine, dichlorobenzidine, 3,3′-dimethoxybenzidine, 4,4′-diaminobenzophenone, N,N-bis(4-aminophenyl)-n-butylamine, N,N-bis(4-aminophenyl)methylamine, 1,5-diaminonaphthalene, 3,3′-dimethyl-4,4′-diaminobiphenyl, 4-aminophenyl-3-aminobenzoate, N,N-bis(4-aminophenyl)aniline, bis(p-β-amino-t-butylphenyl)ether, p-bis-2-(2-methyl-4-aminopentyl)benzene, p-bis(1,1-dimethyl-5-aminopentyl)benzene, 1,3-bis(4-aminophenoxy)benzene, m-xylenediamine, p-xylenediamine, 4,4′-diaminodiphenyl ether phosphine oxide, 4,4′-diaminodiphenyl N-methyl amine, 4,4′-diaminodiphenyl N-phenyl amine, amino-terminal polydimethylsiloxanes, amino-terminal polypropyleneoxides, amino-terminal polybutyleneoxides, 4,4′-methylene-bis(2-methylcyclohexylamine), 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-methylene-bis-benzeneamine, 2,2′-bis[4-(4-aminophenoxy)phenyl]propane, 2,2′-dimethylbenzidine, bisaniline-p-xylidene, 4,4′-bis(4-aminophenoxy) biphenyl, 3,3′-bis(4-aminophenoxy)biphenyl, 4,4′-(1,4-phenylenediisopropylidene)bisaniline, 4,4′-(1,3-phenylenediisopropylidene) bisaniline.

In some embodiments, an anhydride is used to make the solid phase of a gel material. In some preferred embodiments, the anhydride comprises hydroquinone dianhydride, 3,3′,4,4′-biphenyl tetracarboxylic dianhydride, pyromellitic dianhydride, 3,3′,4,4′-benzophenone tetracarboxylic dianhydride, 4,4′-oxydiphthalic anhydride, 3,3′,4,4′-diphenylsulfonet etracarboxylic dianhydride, 4,4′-(4,4′-isopropylidenediphenoxy)bis(phthalic anhydride), 2,2-bis(3,4-dicarboxyphenyl)propane dianhydride, 4,4′-(hexafluoroisopropylidene)diphthalic anhydride, bis(3,4-dicarboxyphenyl) sulfoxide dianhydride, a polysiloxane-containing dianhydride, 2,2′,3,3′-biphenyltetracarboxylic dianhydride, 2,3,2′,3′-benzophenonetetraearboxylic dianhydride, 3,3′,4,4′-benzophenonetetraearboxylic dianhydride, naphthalene-2,3,6,7-tetracarboxylic dianhydride, naphthalene-1,4,5,8-tetracarboxylidei anhydride, 4,4′-oxydiphthalic dianhydride, 3,3′,4,4′-biphenylsulfonate tetracarboxylic dianhydride, 3,4,9,10-perylene tetracarboxylic dianhydride, bis(3,4-dicarboxyphenyl)sulfide dianhydride, bis(3,4-dicarboxypheny 1)methane dianhydride, 2,2-bis(3,4-dicarboxyphenyl)propane dianhydride, 2,2-bis(3,4-dicarboxyphenyl)hexafluoropropane dianhydride, 2,6-dichloronaphthalene-1,4,5,8-tetracarboxylic dianhydride, 2,7-dichloronapthalene-1,4,5,8-tetracarboxylic dianhydride, 2,3,6,7-tetrachloronaphthalene-1,4,5,8-tetracarboxvlic dianhvdride, phenanthrene-7,8,9,10-tetracarboxylic dianhydride, pyrazine-2,3,5,6-tetracarboxylic dianhydride, benzene-1,2,3,4-tetracarboxylic dianhydride, and/or thiophene-2,3,4,5-tetracarboxylic dianhydride.

In some embodiments, a crosslinking agent is used to make the solid phase of a gel material. In some preferred embodiments, the crosslinking agent comprises a triamine, an aliphatic triamine, an aromatic triamine, 1,3,5-tri(4-aminophenoxy)benzene, a silica cage structure decorated with three or more amines, octa(aminophenyl)silsesquioxane, octa(aminophenyl)silsesquioxane as a mixture of isomers having the ratio meta:ortho:para of 60:30:10, p-octa(aminophenyl)silsesquioxane, glutaraldehyde, 1-ethyl-3-(3-dimethylaminopropyl)carbodiimide, N-hydroxysuccinimide, bisphenol-A diglycidyl ether.

In some embodiments, a carboxylic acid is used to make the solid phase of a gel material. In some preferred embodiments, the carboxylic acid comprises trimesic acid, oxalic acid, malonic acid, succinic acid, glutaric acid, adipic acid, pimelic acid, suberic acid, azelaic acid, sebacic acid, pyridine-2,4-dicarboxylic acid, terephthalic acid, or another suitable carboxylic acid.

In some embodiments, a polyol is used to make the solid phase of a gel material. In some preferred embodiments, the polyol comprises resorcinol, phloroglucinol, bisphenol A, tris(hydroxyphenyl)ethane, sulfonyldiphenol, dihydroxybenzonphenone, a polyether alcohol, ethylene glycol, propylene glycol, or another suitable polyol.

In some embodiments, suitable gel materials may be reinforced with a fiber, a fibrous batting, aligned fibers, chopped fibers, or another suitable material. In some of these embodiments, the fiber comprises silica, glass, carbon, a polymer, poly(acrylonitrile), oxidized poly(acrylonitrile), poly(p-phenylene-2,6-benzobisoxazole) (e.g., Zylon®), poly(paraphenylene terephthalamide) (e.g., Kevlar®), ultrahigh molecular weight polyethylene (e.g., Spectra® or Dyneema®), poly(hydroquinone diimidazopyridine) (e.g., M5), polyamide (e.g., Nylon®), natural cellulose, synthetic cellulose, silk, viscose (such as Rayon®), a biologically-derived fiber, a biologically-inspired fiber, a ceramic, alumina, silica, zirconia, yttria-stabilized zirconia, hafnia, boron, metal/metalloid carbide (e.g., silicon carbide), metal/metalloid nitride (e.g., boron nitride), nanotubes carbon nanotubes, carbon nanofibers, boron nitride nanotubes, oxide nanotubes.

In some embodiments, an aerogel material is produced. Aerogel materials may be composed of any suitable composition. In some embodiments, suitable compositions include aerogels comprising a polyurea, a polyurethane, a polyisocyanate, a polyisocyanurate, a polyimide, a polyamide, a polyaramid, a polybenzoxazine, a polyetheretherketone, a polyetherketoneketone, a polybenzoxazole, a poly(acrylonitrile), a phenolic polymer, a resorcinol-formaldehyde polymer, a melamine-formaldehyde polymer, a resorcinol-melamine-formaldehyde polymer, a furfural-formaldehyde polymer, an acetic-acid-based polymer, a polymer-crosslinked oxide, a silica-polysaccharide polymer, a silica-pectin polymer, a polysaccharide, amorphous carbon, graphitic carbon, graphene, diamond, boron nitride, an alginate, a chitin, a chitosan, a pectin, a gelatin, a gelan, a gum, a cellulose, a virus, a biopolymer, an ormosil, an organic-inorganic hybrid material, a rubber, a polybutadiene, a poly(methyl pentene), a polypentene, a polybutene, a polyethylene, a polypropylene, a carbon nanotube, a boron nitride nanotube, graphene, two-dimensional boron nitride. In some embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyisocyanate, polyurea, polyurethane, polyisocyanurate, polyimide, polyamide, polyaramid, polybenzoxazine, poly(acrylonitrile), resorcinol-formaldehyde, silica, or combinations thereof. In some embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyisocyanate, polyurea, polyurethane, polyisocyanurate, polyimide, polyamide, polyaramid, polybenzoxazine, poly(acrylonitrile), resorcinol-formaldehyde polymer, silica, or combinations thereof. In some embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyurea, polyurethane, polyisocyanate, polyisocyanurate, polyimide, polyamide, polyaramid, polybenzoxazine, polyetheretherketone, polyetherketoneketone, polybenzoxazole, phenolic polymer, resorcinol-formaldehyde polymer, melamine-formaldehyde polymer, resorcinol-melamine-formaldehyde polymer, furfural-formaldehyde polymer, acetic-acid-based polymer, polymer-crosslinked oxide, silica-polysaccharide polymer, silica-pectin polymer, polysaccharide, amorphous carbon, graphitic carbon, graphene, diamond, boron nitride, alginate, chitin, chitosan, pectin, gelatin, gelan, gum, cellulose, virus, biopolymer, ormosil, organic-inorganic hybrid material, rubber, polybutadiene, poly(methyl pentene), polypentene, polybutene, polyethylene, polypropylene, carbon nanotubes, boron nitride nanotubes, graphene, two-dimensional boron nitride, or combinations thereof. According to certain embodiments, the gel from which the aerogel is made can include a solid network that includes any of the components above, optionally in the amounts described above.

In certain embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyurea, polyimide, polyurethane, and/or polyamide. In certain embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyurea. In certain embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyimide. In certain embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyurethane. In certain embodiments, at least about 50 wt %, at least about 60 wt %, at least about 70 wt %, at least about 80 wt %, at least about 90 wt %, at least about 95 wt %, at least about 99 wt %, at least about 99.9 wt %, or all of the aerogel is made up of polyamide. According to certain embodiments, the gel from which the aerogel is made can include a solid network that includes any of the components above (e.g., polyurea, polyimide, polyurethane, and/or polyamide), optionally in the amounts described above.

In some embodiments, a dried or substantially-dried aerogel material (dried by any appropriate method) has a compressive modulus (also known as Young's modulus, in some embodiments approximately equal to bulk modulus) proportional to its gel precursor's compressive modulus. For example, a gel whose aerogel has a low modulus will be much more compliant than a gel whose aerogel has a high modulus. Compressive modulus and yield strength may be measured using the method outlined in ASTM D1621-10 “Standard Test Method for Compressive Properties of Rigid Cellular Plastics” followed as written with the exception that specimens are compressed with a crosshead displacement rate of 1.3 mm/s (as prescribed in ASTM D695) rather than 2.5 mm/s. In some cases, the compressive modulus of the aerogel material may be measured after freeze drying and removal of the solvent has occurred. In some cases, the compressive modulus of the aerogel material may be measured after supercritical drying and removal of the solvent or pore fluid has occurred. That is, the mechanical properties (e.g., compressive modulus, yield strength, etc.) of the aerogel material may refer to the mechanical properties of the backbone of the gel, absent the solvent or pore fluid. The aerogel material's compressive modulus may serve as a meaningful indicator if its gel precursor has a compressive modulus high enough such that evaporative drying of the gel precursor from low-surface-tension solvents may result in a monolithic aerogel. In some cases, the compressive modulus of the aerogel material may be measured after evaporative drying and removal of the solvent has occurred. In some cases, the compressive modulus of the aerogel material may be measured after supercritical drying and removal of the solvent has occurred.

In some embodiments, a dried or substantially-dried aerogel material (dried by any appropriate method) has a compressive yield strength proportional to its gel precursor's compressive yield strength. For example a gel whose aerogel has a low yield strength will deform plastically more easily than a gel whose aerogel has a high yield strength. In some embodiments the aerogel material's compressive yield strength may serve as a meaningful indicator if its gel precursor has a compressive yield strength high enough such that evaporative drying of the gel precursor may result in a monolithic aerogel.

In some embodiments, a dried or substantially-dried aerogel material (dried by any appropriate method) has a bulk density proportional to its gel precursor's bulk density. For example a gel whose aerogel has 95% porosity will have a density equivalent to the sum of 95% of the solvent density and 5% of the backbone density, while a gel whose aerogel has 99% porosity will have a density equivalent to the sum of 99% of the solvent density and 1% of the backbone density. In some embodiments the aerogel material's bulk density may serve as a meaningful indicator if its gel precursor has a bulk density appropriate such that evaporative drying of the gel precursor may result in a monolithic aerogel. One of ordinary skill in the art would know how to determine the bulk density of a material by dimensional analysis. For example, bulk density may be measured by first machining a specimen into a block. The length, width, and thickness (or length and diameter) may be measured using digital calipers. These measurements may then be used to calculate the specimen volume. Mass may be measured using a digital analytical balance with a precision of 0.001 g. Bulk density may then be calculated as density=mass/volume.

The resulting aerogel may exhibit any suitable compressive modulus. In some preferred embodiments, the compressive modulus of the resulting aerogel is greater than 100 kPa, greater than 500 kPa, greater than 1 MPa, greater than 10 MPa, greater than 50 MPa, greater than 100 MPa; or less than 100 MPa, less than 50 MPa, less than 10 MPa, less than 1 MPa, less than 500 kPa, less than 100 kPa. Combinations of the above noted ranges, or values outside of these ranges, are possible for the compressive modulus of the resulting aerogel.

The resulting aerogel may exhibit any suitable compressive yield strength. In some preferred embodiments, the compressive yield strength of the resulting aerogel is greater than 40 kPa, greater than 100 kPa, greater than 500 kPa, greater than 1 MPa, greater than 5 MPa, greater than 10 MPa, greater than 50 MPa, greater than 100 MPa, greater than 500 MPa; or less than 500 MPa, less than 100 MPa, less than 50 MPa, less than 10 MPa, less than 5 MPa, less than 1 MPa, less than 500 kPa, less than 100 kPa, or less than 50 kPa. Combinations of the above noted ranges, or values outside of these ranges, are possible for the compressive yield strength of the resulting aerogel.

The resulting aerogel may exhibit any suitable compressive ultimate strength. In some preferred embodiments, the compressive ultimate strength of the resulting aerogel is greater than 1 MPa, greater than 10 MPa, greater than 50 MPa, greater than 100 MPa, greater than 500 MPa, greater than 1000 MPa; or less than 1000 MPa, less than 500 MPa, less than 100 MPa, less than 50 MPa, less than 10 MPa, less than 5 MPa, or less than 1 MPa. Combinations of the above noted ranges, or values outside of these ranges, are possible for the compressive ultimate strength of the resulting aerogel.

The resulting aerogel may exhibit any suitable elasticity. In some embodiments, aerogel materials that exhibit high elasticity may be produced. Elasticity may refer to the degree of strain a material may undergo—relative to its unstrained state—without retaining permanent deformation, e.g., its elastic deformation regime. In some embodiments, materials that exhibit a high degree of elasticity, e.g., greater than about 10%, greater than about 20%, greater than about 30%, greater than about 40%, greater than about 50%, greater than about 60%, greater than about 70%, greater than about 80%, or more, may be produced. In some embodiments, materials that exhibit a high degree of elasticity and exhibit bulk densities less than about 0.05 g/cc or greater than about 0.3 g/cc may be produced.

The resulting aerogel may exhibit any suitable bulk density. One of ordinary skill in the art would know how to determine the bulk density of a material by dimensional analysis. For example, bulk density may be measured by first machining a specimen into a block. The length, width, and thickness (or length and diameter) may be measured using digital calipers. These measurements may then be used to calculate the specimen volume. Mass may be measured using a digital analytical balance with a precision of 0.001 g. Bulk density may then be calculated as density=mass/volume. In some embodiments the bulk density of the aerogel may be between about 0.05 g/cc and about 0.1 g/cc, between about 0.05 g/cc and about 0.2 g/cc, between about 0.05 g/cc and about 0.3 g/cc, between about 0.05 and about 0.4 g/cc, between about 0.05 g/cc and about 0.5 g/cc, between about 0.05 g/cc and about 0.6 g/cc, between about 0.05 g/cc and about 0.7 g/cc, or greater than 0.7 g/cc. In some preferred embodiments the density may between about 0.15 g/cc and 0.7 g/cc.

The resulting aerogel may exhibit any suitable skeletal density. One of ordinary skill in the art would appreciate that skeletal density refers to density of the solid component of the aerogel (which does not include the volume of the pores) as opposed to the bulk density of the aerogel (which includes the volume of its pores). Skeletal density may be measured by measuring the skeletal volume of specimen using a pycnometer, for example, a Micromeritics AccuPyc II 1340 Gas Pycnometer, employing helium as the working gas. Specimens may be dried under a flow of nitrogen or helium prior to measurement to remove moisture or other solvent from the pores of the aerogel. Skeletal volume measurements may be taken by averaging 100 measurements. Mass may be measured using a digital analytical balance with a precision of 0.001 g. Skeletal density may be calculated as skeletal density=mass/skeletal volume. In some embodiments, the skeletal density of the aerogel is between about 1 g/cc and 1.1 g/cc, between about 1 g/cc and 1.2 g/cc, between about 1 g/cc and 1.3 g/cc, between about 1 g/cc and 1.4 g/cc, between about 1 g/cc and 1.5 g/cc, between about 1 g/cc and 1.6 g/cc, between about 1 g/cc and 1.7 g/cc, between about 1 g/cc and 1.8 g/cc, between about 1 g/cc and 1.9 g/cc, between about 1.1 g/cc and 1.3 g/cc, between about 1.1 g/cc and 1.4 g/cc, between about 1.8 g/cc and 2.1 g/cc, between about 1.8 g/cc and 2.2 g/cc, between about 3 g/cc and 4 g/cc, between about 4 g/cc and 5 g/cc.

The resulting aerogel may exhibit any suitable thermal conductivity. In some preferred embodiments, the thermal conductivity of the resulting aerogel is less than about 60 mW/m-K, less than about 50 mW/m-K, less than about 40 mW/m-K, less than about 30 mW/m-K, less than about 20 mW/m-K, between about 15 and 20 mW/m-K, between about 15 and 30 mW/m-K, between about 15 and 40 mW/m-K. An exemplary method for measuring thermal conductivity is as follows. Thermal conductivity may be measured using an apparatus in which an aerogel sample (the mass, thickness, length, and width of which have been measured as explained the procedure for measuring bulk density) is placed in series with a standard reference material (NIST SRM 1453 EPS board) of precisely known thermal conductivity, density, and thickness, between a hot surface and a cold surface. The hot side of the system comprises an aluminum block (4″×4″×1″) with three cartridge heaters embedded in it. The cartridge heaters are controlled by a temperature controller operating in on/off mode. The set-point feedback temperature for the controller is measured at the center of the top surface of the aluminum block (at the interface between the block and the aerogel sample) by a type-K thermocouple (referred to as TC_H). A second identical thermocouple is placed directly beside this thermocouple (referred to as TC_1). The aerogel sample is placed on top of the aluminum block, such that the thermocouples are near its center. A third identical thermocouple (TC_2) is placed directly above the others at the interface between the aerogel sample and the reference material. The reference material is then placed on top of the aerogel sample covering the thermocouple. A third identical thermocouple (TC_3) is placed on top of the reference material, in line with the other three thermocouples. Atop this stack of materials is placed a 6″ diameter stainless steel cup filled with ice water, providing an isothermal cold surface. Power is supplied to the heaters and regulated by the temperature controller such that the hot side of the system is kept at a constant temperature of 37.5° C. After ensuring all components are properly in place, the system is turned on and allowed to reach a state of equilibrium. At that time, temperatures at TC_1, TC_2, and TC_3 are recorded. This recording is repeated every 15 minutes for one hour. From each set of temperature measurements (one set being the three temperatures measured at the same time), the unknown thermal conductivity can be calculated as follows. By assuming one-dimensional conduction (i.e., neglecting edge losses and conduction perpendicular to the line on which TC_1, TC_2, and TC_3 sit) one can state that the heat flux through each material is defined by the difference in temperature across that material divided by the thermal resistance per unit area of the material (where thermal resistance per unit area is defined by R″=t/k, where t is thickness in meters and k is thermal conductivity in W/m-K). By setting the heat flux through the aerogel equal to the heat flux through the reference material, the thermal conductivity of the aerogel can be solved for (the only unknown in the equation). This calculation is performed for each temperature set, and the mean value is reported as the sample thermal conductivity. The thermocouples used can be individually calibrated against a platinum RTD, and assigned unique corrections for zero-offset and slope, such that the measurement uncertainty is ±0.25° C. rather than ±2.2° C.

The resulting aerogel may exhibit any suitable transparency. In some preferred embodiments, the transparent aerogel allows at least about 50%, at least about 60%, at least about 70%, at least about 80%, at least about 90%, at least about 95%, or more transmission of light per cm of aerogel thickness over the range of wavelengths of 480 nm to 750 nm. Other degrees of transparency over ranges of wavelengths are also suitable.

In some preferred embodiments, the resulting aerogel is not friable. In some preferred embodiments, a monolithic aerogel (as understood by those of skill in the art) is produced. In some preferred embodiments, a substantially crack-free aerogel is produced. A crack generally refers to a separation, gap, or line in the material comprising a specimen. Cracks may be determined by observation of a sample. Cracks on the interior of a sample may be recognized by cutting a cross section of a specimen and counting cracks on the inside of the sample. Cracks may be recognized with or without the aid of a microscope. A crack may be located within the volume or on the outer edges of a specimen. Crack density may be calculated by considering the number of cracks in a specimen divided by volume of the specimen. A substantially crack-free aerogel is an aerogel that has fewer than or equal to one crack per cubic centimeter of the aerogel. In some embodiments, the substantially crack-free aerogel has fewer than or equal to one crack per 10 cubic centimeters, fewer than or equal to one crack per 100 cubic centimeter. Cracks may form after the gel forms and may result from a drying process. Cracks may range from microns to cm in length, may be less than microns in length, or may be more than cm in length. In some embodiments, the substantially crack-free aerogel may include an aerogel that does not contain cracks greater than the critical flaw size of the material that the aerogel is made of. In some embodiments, the substantially crack-free aerogel does not contain cracks greater than or equal to 1 cm long, greater than or equal to 1 mm long, greater than or equal to 1 μm long.

In some embodiments, the resulting aerogel is not brittle. Those of ordinary skill in the art would understand a material to not be brittle if a load is applied to a specimen of the material and it undergoes plastic deformation before experiencing failure. A non-brittle material is a material that is not brittle.

In some embodiments, the resulting aerogel has a maximum operating temperature. The maximum operating temperature of an aerogel is the temperature at which the material undergoes deleterious chemical, mechanical, phase, and/or density changes that cause the aerogel to lose mechanical integrity and/or most of its porosity. In some embodiments, the maximum operating temperature is determined by placing the aerogel in an oven at a temperature under a suitable atmosphere, allowing the aerogel to equilibrate to the temperature of the oven, and observing if the aerogel breaks into multiple pieces or densifies to a degree that it loses most of its porosity due to heating. Suitable atmospheres for determining maximum operating temperature include those atmospheres under which the aerogel is expected to operate. Suitable atmospheres for determining maximum operating temperature may include air, nitrogen, argon, vacuum, or any other suitable atmosphere.

In some preferred embodiments, a relatively thin aerogel material is produced. In some preferred embodiments, the thickness of the aerogel is less than about 1 mm. In some preferred embodiments, the aerogel is flexible.

The resulting aerogel may exhibit any suitable dimensions compared to the original gel precursor. One of ordinary skill in the art would appreciate that articles such as aerogels exist in a three-dimensional space and have three orthogonal dimensions, length, width, and height, and that each of the three dimensions are orthogonal to each other. The term thickness may also refer to one of these dimensions, e.g., height. In some preferred embodiments, the dimensions of the aerogel are within about 1%, within 2%, within 5%, within 10%, within 20%, or within 50% of the original gel precursor. In some embodiments, at least one or at least two dimensions of the aerogel are within about 1%, within 2%, within 5%, within 10%, within 20%, or within 50% of the corresponding dimension of the gel precursor. Dimensions of a gel precursor may be measured by selecting two points on the gel precursor and measuring the distance between them with a measuring tool. Dimensions of an aerogel may be measured by selecting two points on the aerogel and measuring the distance between them with a measuring tool. Dimensions of an aerogel that may be compared with the corresponding dimensions of its gel precursor may include length, width, and height of the aerogel and gel precursor. Dimensions of the aerogel outside of these ranges may be possible.

The resulting aerogel may exhibit any suitable volume compared to the original gel precursor. In some preferred embodiments, the volume of the aerogel is within about 1%, within 2%, within 5%, within 10%, within 20%, within 50% of the original gel precursor.

The resulting aerogel may exhibit any suitable internal surface area. In some preferred embodiments, the internal surface area of the aerogel is within 1%, within 5%, within 10%, within 20%, within 50% of the internal surface area of an aerogel supercritically dried from the same gel precursor. In some embodiments, the internal surface area of the aerogel is greater than about 50 m²/g, greater than about 100 m²/g, greater than about 200 m²/g, greater than about 300 m²/g, greater than about 400 m²/g, greater than about 500 m²/g, greater than about 600 m²/g, greater than about 700 m²/g, greater than about 800 m²/g, greater than about 1000 m²/g, greater than about 2000 m²/g, greater than about 3000 m²/g, less than about 4000 m²/g. In some preferred embodiments, the internal surface area of the aerogel is between about 50 m²/g and about 800 m²/g. Values of the internal surface area of the aerogel outside of these ranges may be possible. One of ordinary skill in the art would know how to determine the internal surface area of an aerogel, for example, using nitrogen adsorption porosimetry. A surface area derived from the Brunauer-Emmett-Teller (BET) model may be used. For example, nitrogen sorption porosimetry may be performed using a Micromeritics Tristar II 3020 surface area and porosity analyzer. Before porosimetry analysis, specimens may be subjected to vacuum of ˜100 torr for 24 hours to remove adsorbed water or other solvents from the pores of the specimens. The porosimeter may provide an adsorption isotherm and desorption isotherm, which comprise the amount of analyte gas adsorbed or desorbed as a function of partial pressure. Specific surface area may be calculated from the adsorption isotherm using the Brunauer-Emmett-Teller (BET) method over ranges typically employed in measuring surface area. Pore width, pore area distribution, and mean pore size may be calculated from the nitrogen desorption isotherm using the Barrett-Joyner-Halenda (BJH) method over ranges typically reemployed in measuring pore width and pore area distribution. Average pore width, e.g., mean pore size, (assuming cylindrical pores) may be calculated using pore width=4*(total specific volume)/(specific surface area) where total specific volume and specific surface area may also be calculated using BJH analysis of the desorption isotherm.

In some embodiments, the aerogel may comprise a carbonizable, or pyrolyzable, polymer. Carbonizable polymers are polymers that, when pyrolyzed under an inert atmosphere, leave a carbonaceous residue, amorphous carbon, graphitic carbon, or in some cases, a metal or metalloid or a metal or metalloid carbide. A carbonizable aerogel comprises a carbonizable polymer. A carbonized derivative of an aerogel may include a carbonized aerogel, e.g., a carbon aerogel, a metal or metalloid aerogel. In some embodiments, the carbonization may be performed by placing a carbonizable aerogel in an inert atmosphere, e.g., under a nitrogen or argon gas, and heating the aerogel to temperatures at which the aerogel carbonizes, e.g., at least about 300° C., at least about 400° C., at least about 500° C., at least about 600° C., at least about 700° C., at least about 800° C., at least about 900° C., at least about 1000° C., at least about 1100° C., at least about 1500° C., at least about 2000° C., at least about 2200° C., at least about 2500° C., at least about 3000° C. In some preferred embodiments, the temperature used to carbonize, or pyrolyze, the aerogel is between about 400° C. and 1100° C. In some embodiments, the carbonizable aerogel comprises an aromatic polymer, a phenolic polymer, a resorcinol-formaldehyde polymer, a silica/aromatic polymer hybrid, a metal and/or metalloid oxide/polymer hybrid, a biopolymer. In some preferred embodiments, the carbonizable aerogel comprises an aromatic polymer. In some embodiments, a carbonized aerogel is a carbonized derivative of an aerogel.

In some embodiments, the pore fluid in the gel may be replaced with a desired solvent (e.g., ethoxynonafluorobutane, dodecafluoro-2-methylpentan-3-one). In some embodiments, an excess of solvent equivalent to at least approximately 2 times, at least approximately 5 times, at least approximately 10 times, at least approximately 20 times, at least approximately 50 times, at least approximately 100 times, or less than approximately 2 times the volume of the gel is used to displace the gel's pore fluid. In some embodiments, an excess of solvent greater than at least approximately 2 times, at least approximately 5 times, or at least approximately 10 times results in densification and/or cracking of the gel. In some embodiments, the gel is soaked in a fraction of the desired excess solvent volume, the pore fluid in the gel and the solvent are allowed to mix, the concentrations of species in the resulting mixture reaches approximately equilibrium, another fraction of new excess solvent is provided, and the process is repeated until the desired quantity of excess solvent has been used. In some embodiments, the purity of the pore fluid in the gel after solvent exchange is within 2 v/v %, within 1 v/v %, within 0.1 v/v %, within 0.05 v/v %, within 0.01 v/v %, within 0.005 v/v %, within 0.001 v/v % of the purity of the original solvent prior to contact with the gel. Values of the purity of the pore fluid in the gel after solvent exchange outside of these ranges may be possible.

In some embodiments, the pore fluid in the gel may be replaced by a desired solvent at a specific temperature. In some embodiments, the pore fluid may be exchanged at a temperature below room temperature, e.g., approximately 15° C. In some embodiments, the pore fluid may be exchanged at a temperature substantially below the boiling point of the solvent, e.g., at least about 40° C., at least about 50° C., at least about 60° C., at least about 70° C., or at least about 80° C. below the boiling point of the solvent. In some embodiments, exchanging the pore fluid at a temperature greater than about 50° C. below the boiling point of the solvent results in shrinkage and/or cracking of the gel. Temperatures outside these ranges may be possible.

In some embodiments, the pore fluid in the gel may be replaced by a desired solvent at a specific temperature. In some embodiments, the pore fluid may be exchanged at a temperature of below about 30° C., below about 20° C., below about 10° C., below about 0° C., below about −10° C., or below about −20° C. In some embodiments, exchanging the pore fluid at a temperature greater than about 15° C. results in shrinkage and/or cracking of the gel. Temperatures outside these ranges may also be possible. In some embodiments, the pore fluid is exchanged at a temperature determined as a fraction of the difference between the boiling temperature and freezing temperature of the target solvent above the freezing temperature of the solvent. In some embodiments, the pore fluid may be exchanged at a temperature below about 0.8, below about 0.75, below about 0.7, below about 0.65, or below about 0.6 of the difference between the boiling temperature and freezing temperature of the solvent above the freezing temperature of the solvent. In some embodiments, exchanging the pore fluid at a temperature greater than about 0.725 of the difference between the boiling temperature and freezing temperature of the solvent above the freezing temperature of the solvent results in shrinkage and/or cracking of the gel. Temperatures outside these ranges may also be possible.

The pore fluid may be exchanged with any suitable solvent. In some embodiments, the pore fluid in the gel is exchanged for an alcohol. In further embodiments, the pore fluid in the gel is exchanged for a ketone. In further embodiments, the pore fluid is exchanged for an ether. In some embodiments, the initial pore fluid may include water, carbon dioxide, methanol, ethanol, isopropanol, n-butanol, sec-butanol, tert-butanol, a pentanol, amyl alcohol, an alcohol, acetone, methyl ethyl ketone, a ketone, acetonitrile, acrylonitrile, N-methylpyrrolidone, a pyrrolidone, N,N′-dimethylformamide, dimethylacetamide, dimethylsulfoxide, or another suitable fluid prior to exchange with organic solvents in accordance with the present disclosure. In further embodiments, the initial pore fluid is displaced by a fluorinated organic solvent. In some embodiments, the gel is synthesized in the presence of a fluorinated organic solvent.

In some embodiments, the pore fluid in the gel and/or the solvent used to replace the pore fluid in the gel is/are degas sed. In some of these embodiments, the pore fluid/solvent is/are degassed by bubbling an inert gas. In some embodiments, the pore fluid/solvent is/are degassed by providing a reduced pressure. In some embodiments, the pore fluid/solvent is/are degassed by providing an elevated temperature. In some embodiments, the pore fluid/solvent is/are degassed for at least approximately 1 min, at least approximately 2 min, at least approximately 10 min, at least approximately 30 min, at least approximately 1 h, at least approximately 2 h, at least approximately 4 h, at least approximately 12 h, at least approximately 24 h, at least approximately 48 h, at least approximately 72 h, or any other appropriate time period.

In some embodiments, the pore fluid is evaporated by exposure to the ambient surroundings (e.g., standard atmospheric conditions or an approximation thereof). In some embodiments, the pore fluid includes a low-surface-tension fluorinated organic solvent and is removed under a vacuum, or other form of air flow. In some embodiments, such a vacuum may be less than about 100 torr, less than about 10 torr, less than about 1 torr, less than about 0.1 torr, less than about 1×10⁻² torr, less than about 1×10⁻³ torr, less than about 1×10⁻⁴ torr, less than about 1×10⁻⁵ torr, less than about 1×10⁻⁶ torr, or any other appropriate pressure. In some preferred embodiments, the pore fluid is removed under substantially dry conditions, i.e., in an atmosphere that contains little or no water vapor. In some embodiments, an atmosphere with a dew point less than or equal to about −40° C. may be considered to contain little water vapor. In some embodiments, the atmosphere comprises dry air. In some embodiments, the atmosphere comprises helium, nitrogen, argon, carbon dioxide, and/or another inert gas. In some embodiments, the dew point of the surrounding atmosphere is less than about 25° C., less than about 10° C., less than about 0° C., less than about −10° C., less than about −25° C., less than about −50° C., or less than about −75° C. Other ranges of dew points are also possible. Values of dew point of the atmosphere surrounding the gel during evaporation of the pore fluid outside of these ranges may be possible. In some embodiments, a dry gas is used. In some embodiments, a dry gas comprises a gas that is substantially free of moisture or humidity, e.g., the dew point of the dry gas is less than about 25° C., less than about 10° C., less than about 0° C., less than about −10° C., less than about −25° C., less than about −50° C., less than about −75° C., or any suitable dew point. In some embodiments, the percentage of moisture in the gas is at least less than about 1%, at least less than about 0.5%, at least less than about 0.1%, at least less than about 0.05%, at least less than about 0.01%, or less.

In accordance with embodiments of the present disclosure, for the first time, aerogel materials can now be synthesized in situ and directly integrated into a variety of applications. For example, in some embodiments, a gel precursor containing a low-surface-tension fluorinated solvent may be injected into a cavity having a relatively large volume, e.g., between two walls, inside a refrigerator, in a mold, etc. The gel then fills the cavity and the solvent spontaneously evaporates therefrom. In some preferred embodiments, the solvent and its vapors are non-flammable. In further embodiments, the solvent and its vapors are generally non-toxic. In some embodiments, the gel material transforms into an aerogel material within about 10 min, 20 min, 30 min, 1 h, 2 h, 5 h, 1 d, 2 d, 5 d, or within another suitable time frame. In some embodiments, holes are introduced into the cavity to permit vapors to escape as they evaporate from the gel.

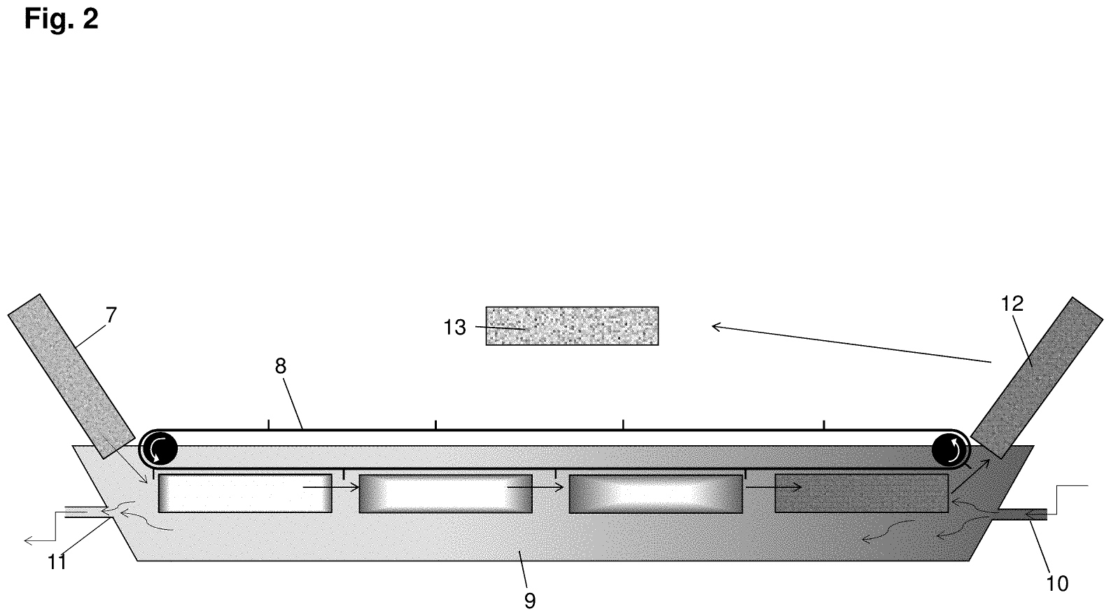

In some embodiments, gels may be produced in a continuous fashion either as a continuous gel slab or as discrete gels on a conveyer belt. FIG. 2 depicts a method for drying gels to make aerogel materials in a continuous method, i.e., a non-batch drying process. In some embodiments, wet gels can be transported through a bath of solvent using, for example, a conveyor or other transport device. The bath may have an inlet and/or an outlet through which the solvent may be transported. In some cases, the solvent may be transported through the bath, for example, in a direction that is substantially opposite (i.e., within 10° of opposite) to the direction in which the gels are transported. For example in FIG. 2, wet gels 7 containing a pore solvent are moved using a conveyer or similar 8 through a counter flow bath 9 comprising fluorinated organic solvent that flows through one end of the bath container 10, and a mixture of fluorinated organic solvent and the original gel pore solvent that is removed from the opposite end 11. As gels move through the bath (e.g., left to right as shown in FIG. 2) the original solvent in the gel can be replaced with fluorinated organic solvent. The gel is removed 12 from the fluorinated organic solvent bath and is evaporatively dried to produce an aerogel 13.

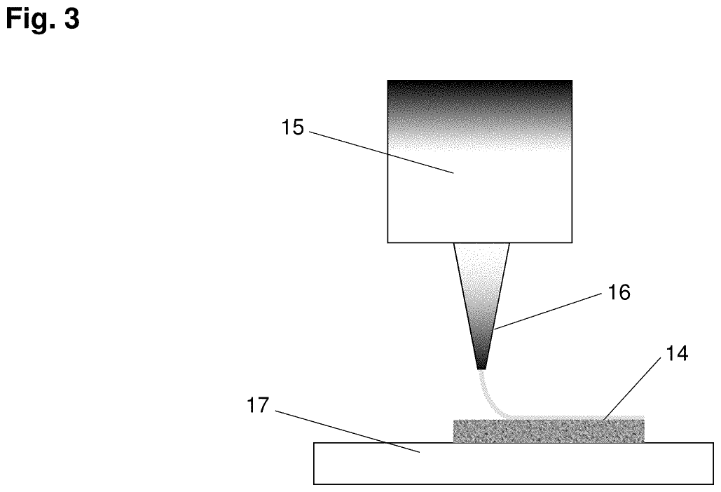

Certain embodiments of the present disclosure allow for aerogel materials to be additively manufactured (3D printed) for the first time. For example, in some embodiments, a sol is present in a reservoir. In some embodiments the sol is pumped from the reservoir. In some embodiments the pumped sol is ejected through a nozzle that dispenses a gel precursor into a desired two-dimensional pattern on a substrate. The gel precursor then gels, forming a two-dimensional patterned gel layer. In some embodiments, movement of the injector nozzle may be directed by a computer or other control system. FIG. 3 depicts a system for manufacturing an aerogel material in which a sol 14 contained in a reservoir 15 is dispensed through a nozzle 16 onto a substrate 17, additively forming a porous gel material have a solvent located within pores of the gel material. The solvent can then be removed leaving behind an aerogel in the shape of the dispensed gel.

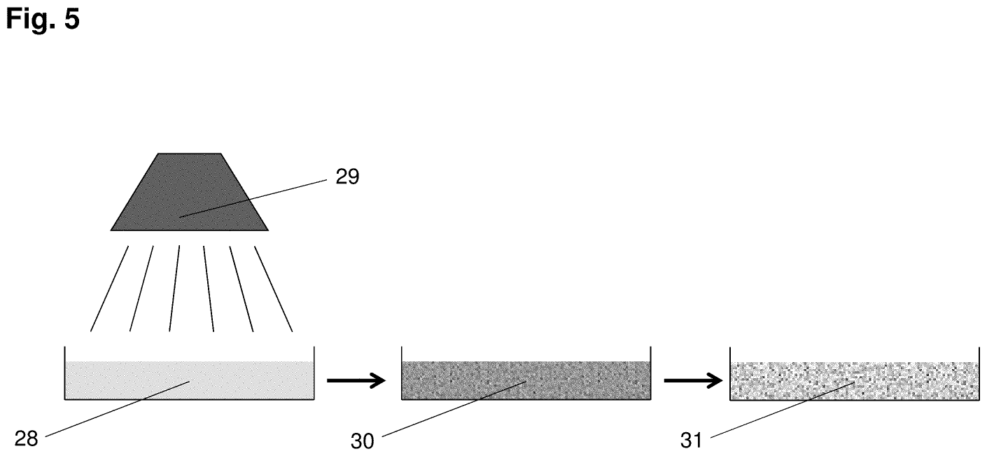

In some preferred embodiments, the gel precursor contains a low-surface-tension fluorinated organic solvent. The two-dimensional patterned layer of gel material is then allowed to evaporatively dry thereby becoming an aerogel layer in the same general shape and pattern as the original gel layer. In some embodiments, the gel material does not initially contain a low-surface-tension fluorinated solvent and is submerged in a bath of an appropriate low-surface-tension fluorinated organic solvent, resulting in exchange of the pore fluid for the low-surface-tension organic fluorinated solvent. The low-surface-tension fluorinated organic solvent is then evaporated, resulting in an aerogel material in the same general shape and pattern as the original gel layer. In some embodiments, additional layers of gel material are added on top of a dispensed gel layer prior to evaporative drying, thereby producing a three-dimensional patterned gel volume. In some embodiments, the three-dimensional patterned gel volume is evaporatively dried, thereby becoming a three-dimensional patterned aerogel part. In some embodiments, a photocurable compound (e.g., resin), for example a compound that may be polymerized wherein the polymerization is activated or initiated by light is provided. In some embodiments the compound may be a resin. In some preferred embodiments, the photocurable compound (e.g., resin) is diluted with a solvent. In some embodiments, the photocurable compound (e.g., resin) is diluted with a solvent that is miscible with a fluorinated organic solvent. In some preferred embodiments, the photocurable compound (e.g., resin) is diluted with a fluorinated organic solvent. In some embodiments, the photocurable compound (e.g., resin) may be cured by exposure to light, for example, ultraviolet light. In some embodiments, exposing the photocurable compound (e.g., resin) to light causes monomers or polymers in the resin to crosslink. In some embodiments, a light such as an ultraviolet light emitting diode or laser is provided. In some preferred embodiments, a light is steered to produce a pattern in the photocurable compound (e.g., resin), and a cured resin in the shape of the light path results. In some preferred embodiments, photocurable compound (e.g., resin) comprises a polymethacrylate, a polyester, an epoxide. In some preferred embodiments, the cured resin contains a fluorinated organic solvent which is evaporated to produce a resin aerogel material. FIG. 5 depicts a method for making an aerogel material in which a sol 28 comprises photocurable compound (e.g., resin) and a fluorinated organic solvent. The sol is exposed to a light source 29 to cure it into a gel 30. The solvent is then allowed to evaporate from the gel leaving an aerogel 31 behind.

In some embodiments, the gel may include holes or channels to facilitate evaporation of solvent located therein. In some embodiments, these holes or channels are spaced at approximately regular intervals. In some embodiments, the diameter of the holes or channels is greater than about 0.1 mm. In some embodiments, the presence of holes or channels may result in faster removal of solvent from the gel than would otherwise be the case without the holes or channels.

In some embodiments, the gel is provided in the form of chunks, granules, aggregates, or particles. In some of these embodiments, drying of these gel chunks, granules, or particles results in aerogel particles. In some embodiments, the gel particles may be dried faster than gel monoliths. In some preferred embodiments, the gel particles comprise silica. In some of these embodiments, the resulting aerogel particles have a thermal conductivity lower than approximately 20 mW/m-K. In some embodiments, the resulting aerogel particles are transparent. In some embodiments, the resulting aerogel particles are hydrophobic.

In some preferred embodiments, an aerogel may be produced having at least one dimension (e.g., thickness, length, width, etc.) greater than 1 cm, greater than 10 cm, greater than 30 cm, greater than 100 cm, greater than 2 m, greater than 5 m, greater than 10 m. In some preferred embodiments, an aerogel with at least two dimensions greater than 1 cm, greater than 10 cm, greater than 30 cm, greater than 100 cm, greater than 2 m, greater than 5 m, greater than 10 m may be produced. In some preferred embodiments, an aerogel with a thickness of greater than 1 mm, greater than 5 mm, greater than 1 cm, greater than 2 cm, greater than 5 cm, greater than 10 cm may be produced.

In some preferred embodiments, the fluorinated organic solvent from the gel is recaptured after it is removed, optionally purified, and used again to prepare another gel for evaporative drying. In some embodiments, more than 50%, more than 60%, more than 70%, more than 80%, more than 90%, more than 95%, more than 99% of the pore fluid is recaptured and recycled.

In some embodiments, a gel for producing an aerogel is made according to methods known in the art. In some preferred embodiments, the gel comprises polyurea, polyisocyanurate, polyisocyanate, polyurethane, polyimide, polyamide, polymer-reinforced oxide, silica, silica-polysaccharide hybrid. In some embodiments, holes or channels are present in the gel. These holes or channels may facilitate diffusion or evaporation of pore fluid out of the gel. In some embodiments, these channels are less than approximately 1 mm in diameter. In some embodiments, these channels are greater than approximately 1 mm in diameter. In some embodiments, these channels extend through the thickness of the gel. In some embodiments, these channels are spaced approximately every 0.1 cm, 0.5 cm, 1 cm, 2 cm, 5 cm, 10 cm apart over the area of the gel. In some embodiments, the pore fluid provided throughout the gel may be exchanged for a solvent, such as low-surface-tension fluorinated organic solvent, as described herein. In some of these embodiments, the pore fluid (e.g., fluorinated organic solvent, other solvent) of the gel contains less than 0.05 v/v % impurities.

In some preferred embodiments, the resulting aerogel materials have desirable materials properties. For example, in some embodiments the aerogel has a maximum operating temperature greater than about 100° C., 200° C., 300° C., 400° C., 500° C. In some embodiments, the aerogel material has superior acoustic damping properties greater than about 5 dB/cm thickness, about 10 dB/cm thickness, about 20 dB/cm thickness, about 40 dB/cm thickness.

### EXAMPLES

### Example 1. Synthesis of Polyurea Aerogel with a Density of 0.166 g/Cc Produced from Reaction of Isocyanate with In-Situ-Formed Amines

A polyurea gel was synthesized from an isocyanate. 26.54 g Desmodur N3300 (isocyanurate trimer of hexamethylene diisocyanate) was dissolved in 158.35 g acetone and stirred until homogenous (approximately 15 minutes). To this mixture 1.87 g deionized water was added and the mixture was stirred for 5 minutes. Finally 0.26 mL triethylamine was added to the mixture and the mixture was stirred an additional 5 minutes. The sol was poured into a mold which was then sealed in a gas-tight container and transferred to a temperature-controlled environment set to 15° C. The gel was allowed to sit for 24 hours, during which time gelation occurs. After 24 hours the gel was removed from the mold and transferred to a solvent exchange bath.

The volume of the first solvent exchange bath was approximately 10 times that of the gel, and was ACS Reagent Grade methanol. The methanol was replaced two times with clean methanol (once every 24 hours), for a total of three exchanges.

After exchange into methanol, the gel was transferred to a solvent exchange bath containing Novec 7200. The volume of the bath was 5 times that of the gel. The solvent in the bath was replaced with fresh Novec 7200 four times, once every 24 hours, for a total of five solvent exchanges. Because Novec 7200 is more dense than the gel network with the fluid originally in the pores (methanol) of the samples was weighted down to prevent them from floating to the surface, which would cause damaging evaporation to occur at the exposed face.

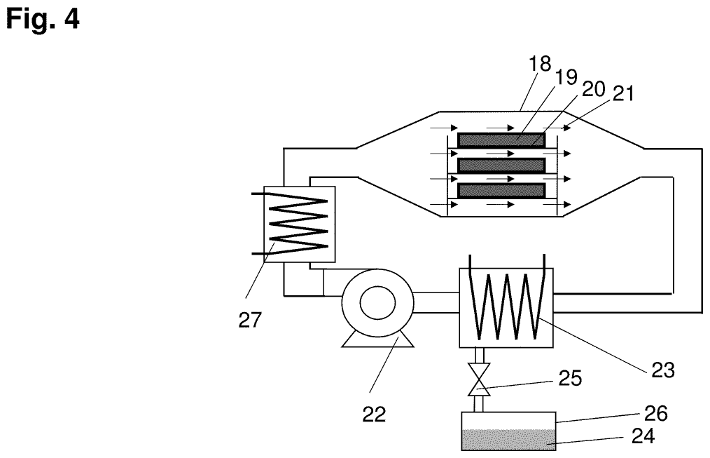

After solvent exchange into Novec 7200 was complete, the gels were removed from the bath and the Novec 7200 was allowed to evaporate. The drying process was performed at typical atmospheric pressure and room temperature. To prevent condensation of water on and within the gel (as it is cooled by endothermic evaporation of Novec 7200) the drying process may be performed in low-humidity air or inert gas (e.g. nitrogen). Alternatively, the gel was dried in a closed loop drying system. Dry air or nitrogen gas was circulated through the system by a fan or blower, such that it flowed over the gel and mixed with Novec 7200 vapor that evaporated from the gel. This vapor-rich flow then passed through a condenser. In some embodiments the temperature in the condenser was more than 10° C. below the temperature in the drying chamber, more than 20° C. below the temperature in the drying chamber, more than 30° C. below the temperature in the drying chamber, more than 50° C. below the temperature in the drying chamber, or more than 75° C. below the temperature in the drying chamber. In some embodiments the temperature in the condenser was lower than the temperature in the drying chamber by a amount within a range bound by any of these temperatures. The condenser removed most of the Novec 7200 vapor. In some embodiments the condenser removed over 90%, over 95%, over 99%, over 99.9%, over 99.99% of the Novec 7200 vapor. The effluent from the condenser was then sufficiently free of Novec 7200 vapor to be recirculated over the gel for continued drying. To accelerate drying, the flow was reheated by an in-line heating element after the condenser and before the gel to increase the evaporation rate and the vapor pressure of the Novec. FIG. 4 depicts a system for drying gels in which a chamber 18 contains gels 19 placed on racks 20 over which a flow of dry air or nitrogen 21 is blown by a blower 22 through heater 27. The effluent from the drying chamber passes through a condenser 23 where solvent 24 condenses and drips through a valve 25 into a reservoir 26.

The resulting aerogel was a white monolith with a bulk density of 0.166 g/cc. The material had a compressive modulus of 25.5 MPa and a compressive yield strength of 1 MPa. It had a thermal conductivity of 25 mW/m-K and skeletal density of about 1.35 g/cc.

### Example 2. Synthesis of Polyurea Aerogel with a Density of 0.2 g/Cc Produced from Reaction of Isocyanate with In-Situ-Formed Amines

A polyurea gel was synthesized from an isocyanate. 158.12 g Desmodur N3300 (isocyanurate trimer of hexamethylene diisocyanate) was dissolved in 592.3 g acetone and stirred until homogenous (approximately 15 minutes). To this mixture 11.14 g deionized water was added and the mixture was stirred for 5 minutes. Finally 0.762 g triethylamine was added to the mixture and the mixture was stirred an additional 5 minutes. The sol was poured into a mold, which was then sealed in a gas-tight container, and transferred to a temperature-controlled environment set to 15° C. The gel was allowed to sit for 24 hours, during which time gelation occurred. After 24 hours the gel was removed from the mold and transferred to a solvent exchange bath. The remainder of the procedure for solvent exchange and drying was carried out as described in Example 1.

The resulting aerogel was a white monolith with a bulk density of 0.2 g/cc. The material had a compressive modulus of 40 MPa and a compressive yield strength of 2 MPa. It had a thermal conductivity of 26 mW/m-K, specific surface area of 150 m²/g, and skeletal density of about 1.35 g/cc.

### Example 3. Synthesis of Polyurea Aerogel with a Density of 0.4 g/Cc Produced from Reaction of Isocyanate with In-Situ-Formed Amines

A polyurea gel was synthesized from an isocyanate. 307.33 g Desmodur N3300 (isocyanurate trimer of hexamethylene diisocyanate) was dissolved in 495.04 g acetone and stirred until homogenous (approximately 15 minutes). To this mixture 21.65 g deionized water was added and the mixture was stirred for 5 minutes. Finally 56 μL triethylamine was added to the mixture and the mixture was stirred an additional 5 minutes. The sol was poured into the mold, which was then sealed in a gas-tight container, and transferred to a temperature-controlled environment set to 15° C. The gel was allowed to sit for 24 hours, during which time gelation occurred. After 24 hours the gel was removed from the mold and transferred to a solvent exchange bath.

The remainder of the procedure for solvent exchange and drying was carried out as described in Example 1.

The resulting aerogel was a white monolith with a bulk density of 0.4 g/cc. The material had a compressive modulus of 150 MPa and a compressive yield strength of 7 MPa. It had a thermal conductivity of 43 mW/m-K, specific surface area of 155 m²/g, and skeletal density of about 1.25 g/cc.

### Example 4. Synthesis of a Polyurethane Aerogel Produced from Reaction of Isocyanate with Polyol

A polyurethane gel was synthesized from an isocyanate and a polyol. The synthesis took part in a dry bag under dry nitrogen. 112.04 g Desmodur RE, a solution of 27 wt % triisocyanatophenylmethane in ethyl acetate, was mixed with 255.94 g 2-butanone and stirred until well mixed (approximately 5 minutes). To this mixture 28.99 g 4,4′-(propane-2,2-diyl)diphenol was added, and stirred for 5 minutes. Finally 0.816 g dibutyltin dilaurate was added, and the mixture was stirred an additional 5 minutes. The sol was poured into a mold, which was then sealed in a gas-tight container containing 2-butanone vapor, and transferred to a temperature-controlled environment set to 15° C. The gel was left at these conditions for 24 hours. After 24 hours the gel was removed from the mold and transferred to a solvent exchange bath.

The volume of the first solvent exchange bath was approximately 10 times that of the gel, and was ACS Reagent Grade acetone. The acetone was replaced two times with clean acetone (once every 24 hours). The volume of the first solvent exchange bath was approximately 10 times that of the gel, and was ACS Reagent Grade methanol. The methanol was replaced two times with clean methanol (once every 24 hours), for a total of three exchanges.

After exchange into methanol the gel was transferred to a solvent exchange bath containing Novec 7200. The volume of the bath was 5 times that of the gel. The solvent in the bath was replaced with fresh Novec 7200 four times, once every 24 hours, for a total of five solvent exchanges. Because Novec 7200 is more dense than the gel network with the fluid originally in the pores (methanol) the samples were weighted down to prevent them from floating to the surface, which would cause damaging evaporation to occur at the exposed face.

After solvent exchange into Novec 7200 was complete, the gels were removed from the bath and the drying process was carried out as described in Example 1.

The resulting aerogel was a white monolith with a bulk density of 0.3 g/cc. The material had a compressive modulus of 67.5 MPa and a compressive yield strength of 3.6 MPa. It had a thermal conductivity of 40.8 mW/m-K, and specific surface area of 110 m²/g.

### Example 5. Synthesis of a Polyimide Aerogel with a Density of 0.22 g/Cc Produced from Reaction of Isocyanate with Anhydride

A polyimide gel was synthesized by reaction of isocyanate and anhydride. The synthesis took place in a dry nitrogen atmosphere. 15.1 g 3,3′,4,4′-benzophenonetetracarboxylic dianhydride was combined with 383.5 g N,N′-dimethylformamide and stirred until the 3,3′,4,4′-benzophenonetetracarboxylic dianhydride was fully dissolved, approximately 10 minutes. To this mixture 41.4 g Desmodur RE solution (27 wt % triisocyanatophenylmethane in ethyl acetate) was added, and the combined mixture was stirred for 10 minutes. The mixture was then poured into molds which were covered but not completely gas-tight (to avoid pressurization during heating) and placed in a temperature-controlled environment in which the air temperature was kept at 70° C. for 3.5 hours. The gels were then allowed to sit for 12 hours at room temperature. After 12 hours the gels were transferred to a solvent exchange bath.

The volume of the first solvent bath was approximately 5 times that of the gel. The gel was first solvent exchanged into N,N′-dimethylformamide for 24 hours, N,N′-dimethylformamide being replaced once after 24 hours. The gel was then exchanged into a mixture which was 4 parts N,N′-dimethylformamide and one part water (by volume) for 24 hours. The gel was then exchanged into ACS Reagent Grade acetone three times for 24 hours each, followed two exchanges into a bath of ACS Reagent Grade methanol, each of the acetone and methanol baths with approximately 10 times the gel volume.

After exchange into methanol the gel was transferred to a second solvent exchange bath containing Novec 7200. The volume of the bath was 5 times that of the gel. The solvent in the bath was replaced with fresh Novec 7200 four times, once every 24 hours, for a total of five solvent exchanges. Because Novec 7200 is more dense than the gel network with the fluid originally in the pores (methanol) the samples were weighted down to prevent them from floating to the surface, which would cause damaging evaporation to occur at the exposed face.

After solvent exchange into Novec 7200 was complete, the gels were removed from the bath, and the drying process was carried out as described in Example 1.

The resulting aerogel was a light green monolith with a bulk density of 0.22 g/cc. It had a thermal conductivity of 20.7 mW/m-K. The material had a compressive modulus of 27 MPa and a compressive yield strength of 1.3 MPa.

### Example 6. Synthesis of a Polyimide Aerogel with a Density of 0.48 g/Cc Produced from Reaction of Isocyanate with Anhydride

A polyimide gel was synthesized by reaction of isocyanate and anhydride. The synthesis took place in a dry nitrogen atmosphere. 60.0 g 3,3′,4,4′-benzophenonetetracarboxylic dianhydride was combined with 306.5 g N,N′-dimethylformamide and stirred until 3,3′,4,4′-benzophenonetetracarboxylic dianhydride was fully dissolved, approximately 10 minutes. To this mixture 165.7 g Desmodur RE solution (27 wt % triisocyanatophenylmethane in ethyl acetate) was added, and the combined mixture was stirred for 10 minutes. The mixture was then poured into molds which were covered but not completely gas-tight (to avoid pressurization during heating), and placed in a temperature-controlled environment in which the air temperature was kept at 70° C. for 3.5 hours. The gels were then allowed to sit for 12 hours at room temperature. After 12 hours the gels were transferred to a solvent exchange bath.

The remainder of the procedure for solvent exchange and drying was carried out as described in Example 5.

The resulting aerogel was a green monolith with a bulk density of 0.48 g/cc. It had a thermal conductivity of 44 mW/m-K. The material had a compressive modulus of 113 MPa and a compressive yield strength of 3 MPa.

### Example 7. Synthesis of a Polyamide Aerogel with a Density of 0.2 g/Cc Produced from Reaction of Amine with Acyl Chloride

A polyamide gel was synthesized by reaction of an amine and an acyl chloride. The synthesis took place in an inert nitrogen atmosphere. 7.6 g anhydrous calcium chloride was dissolved in 226.6 g N-methyl-2-pyrrolidone and stirred until fully dissolved (no particulates visible). 8.9 g p-phenylenediamine was added to the mixture and stirred until fully dissolved (no particulates visible). The mixture was cooled to 5° C. in an ice water bath. After the mixture reaches target temperature, 16.3 g terephthaloyl chloride was added. The mixture was stirred for 2 minutes (remaining in the ice bath for continued cooling). After mixing for 2 minutes the sol was poured into a mold. The mold was sealed and placed in an air-tight container, and left for 24 hours at room temperature. After 24 hours the gel was removed from its mold and transferred to a solvent exchange bath.

The remainder of the procedure for solvent exchange and drying was carried out as described in Example 1.

The resulting aerogel was a light beige monolith with a bulk density of 0.2 g/cc.

### Example 8. Synthesis of a Polymer-Crosslinked Silica Aerogel

A gel was made by reinforcing the oxide backbone of a silica gel with a conformal polyisocyanate network. A solution referred to as part A was made by mixing 27.51 g acetonitrile, 12.2 g tetramethoxysilane, and 3.74 g (3-aminopropyl)triethoxysilane. A solution referred to as part B was made by mixing 27.51 g acetonitrile and 11.1 g deionized water. Both solutions were then cooled by placing their mixing beakers in an acetone-dry ice bath until the temperature equilibrates. Part B (which at this point was a slush) was then added to Part A, and the combined mixture was stirred aggressively. After the two parts were well mixed (<1 minute of aggressive stirring) the sol was poured into a mold, which was sealed in a closed, gas-tight container. The gel was allowed to sit for 24 hours in this environment. After 24 hours the gel was removed from its mold and transferred into a bath containing a well-mixed solution of 314.4 g acetonitrile and 80.57 g Desmodur N3200 (biuret of hexamethylene diisocyanate), in which it soaked for 24 hours. The gel was then transferred into a bath of fresh acetonitrile approximately of four times the volume of the gel and placed in an oven at 70° C. for 72 h. The gel was then removed from the oven and subjected to another three solvent exchanges into fresh acetonitrile baths with 10 times the volume of the gel. The gel was then transferred to a solvent exchange bath that was approximately 10 times that of the gel which contained ACS Reagent Grade methanol. The methanol was replaced two times with clean methanol (once every 12 hours).

After exchange into methanol the gel was transferred to a solvent exchange bath containing Novec 7200. The volume of the bath was 5 times that of the gel. The solvent in the bath was replaced with fresh Novec 7200 and was replaced four times, once every 24 hours, for a total of five solvent exchanges. Because Novec 7200 is more dense than the gel network with the fluid originally in the pores (methanol) the samples were weighted down to prevent them from floating to the surface, which would cause damaging evaporation to occur at the exposed face.

After solvent exchange into Novec 7200 was complete the gels were removed from the bath, and the drying process was carried out as described in Example 1.

The resulting aerogel was a translucent white monolith with a bulk density of 0.53 g/cc. The material had a compressive modulus of 77.3 MPa and a compressive yield strength of 3.4 MPa. It had a mean pore diameter of 15 nm, and specific surface area of 110 m²/g.

### Example 9. Synthesis of Aromatic Polyurea Aerogel

A polyurea gel was synthesized by reaction of an amine and an isocyanate. 1.8 g oligomeric methylene diphenyl diisocyanate (Lupranat® M20) was dissolved in 12 g ethyl acetate in a glass beaker while stirring at 20° C. In another beaker 1.6 g 3,3′,5,5′-tetramethyl-4,4′-diaminophenylmethane and 0.1 g N,N′,N″-tris(dimethylaminopropyl)-s-hexahyrotriazine were dissolved in 12.5 g ethyl acetate. The contents of the two beakers were mixed and allowed to rest at room temperature for 24 hours. After 24 hours the gel was removed from its mold and transferred to a solvent exchange bath.

The remainder of the procedure for solvent exchange and drying was carried out as described in Example 1.

The resulting aerogel was a white/beige monolith with a bulk density of 0.2 g/cc, thermal conductivity of 18 mW/m-K, and specific surface area of 304 m²/g.

### Example 10. Preparation of a Polyurea Aerogel Having a Density of 0.2 g/Cc

To 23.73 g of acetone was added 6.33 g of Desmodur N3300 (aliphatic triisocyanate) to form a 0.43 molar solution. The solution was mixed until homogenous. To this solution was added 0.446 mL (1.92 molar equivalent relative to Desmodur N3300) of water. The solution was mixed. To this mixed solution was added 0.42 mL (0.1 w/w %) of triethylamine catalyst. The solution was mixed for 5 minutes. The resulting sol was then poured into molds and allowed to gel under a saturated acetone atmosphere.

Gelation occurred within an hour and the resulting gels were aged for 18 hours. After aging, the pore fluid in the gels was exchanged with Novec 7200, a low-surface-tension fluorinated organic solvent, by soaking in a bath of the solvent having a volume five times that of the volume of the gels. The gels were then soaked in the bath for 24 hours. This was repeated five times over the course of five days. Alternatively, a continuous flow of the target solvent has been introduced over the gels.

Finally, the gels were dried by removing them from the low-surface-tension fluorinated organic solvent bath and allowing the solvent to evaporate from the gels resulting in polyurea aerogels. Aerogels with a thickness of approximately 1 cm were obtained in as little as 20 min.

### Example 11. Preparation of a Polyimide Aerogel Having a Density of 0.4 g/Cc

To 13.71 g of N-methyl-2-pyrrolidone was added 0.55 g of pyromellitic dianhydride and 0.57 g of 85 w/w % trisisocyanatophenylmethane in ethyl acetate (e.g., Desmodur RE) to give a 1.6:1 molar ratio of pyromellitic dianhydride to trisisocyanatophenylmethane. The solution was mixed for 1 hour. The resulting sol was heated at 60° C. until gelation occurred. The temperature was then ramped to 90° C. at a rate of 10° C. per hour and the gels were annealed at 90° C. for three hours. The pore fluid in the gels was then exchanged into ethanol by soaking the gels in a bath of absolute ethanol with a volume of three times the volume of the gels for 24 hours. This was repeated three times over the course of three days.

The pore fluid in the gels was exchanged with Novec 7200, a low-surface-tension fluorinated organic solvent, by soaking in a bath of the target solvent having a volume five times that of the volume of the gels. The gels were then soaked in the bath for 24 hours. This was repeated five times over the course of five days. Alternatively, a continuous flow of the target solvent has been introduced over the gels.

Finally, the gels were dried by removing them from the low-surface-tension fluorinated organic solvent bath and allowing the solvent to evaporate from the gels resulting in polyimide aerogels. Aerogels with a thickness of approximately 1 cm were obtained in as little as 20 min.

### Example 12. Preparation of a Polyurethane Aerogel with Density of 0.4 g/Cc

To 39.55 g of acetone was added 5.52 g of Desmodur N3300 (aliphatic triisocyanate) and 3.45 g of 1,1,1-tris-(4-hydroxyphenyl)ethane to give a 1:1 molar ratio. The solution was mixed until the monomers were dissolved. This formed a solution with a 0.45 M concentration of reactants in acetone. To this solution was added 0.055 mL of dibutyltin dilaurate catalyst to give a molar ratio of Desmodur N3300 to dibutyltin dilaurate of 120:1. The solution was mixed for 20 minutes. The resulting sol was then poured into molds and allowed to gel under a saturated acetone atmosphere. Gelation occurred within eight to ten hours. Without aging, the gels were solvent exchanged with methanol by soaking the gels in a bath of at least three times excess methanol relative to the volume of the gels for 24 h repeated three times over the course of three days.

The pore fluid in the gels was then exchanged with Novec 7200, a low-surface-tension fluorinated organic solvent, by soaking in a bath of the solvent having a volume five times that of the volume of the gels. The gels were then soaked in the bath for 24 hours. This was repeated five times over the course of five days. Alternatively, a continuous flow of the target solvent has been introduced over the gels.

Finally, the gels were dried by removing them from the low-surface-tension fluorinated organic solvent bath and allowing the solvent to evaporate from the gels resulting in polyurethane aerogels. Aerogels with a thickness of approximately 1 cm were obtained in as little as 20 min.

### Example 13. Preparation of a Polyurethane Aerogel Having a Density of 0.15 g/Cc

To 30 g of acetone was added 2.39 g of 85 w/w % trisisocyanatophenylmethane in ethyl acetate and 1.74 g of 1,1,1-tris(4-hydroxyphenyl)ethane. The solution was mixed until the monomers were dissolved. This formed a solution with a 0.3 M concentration of reactants in the solution. To this solution was added 0.056 mL of dibutyltin dilaurate catalyst to give a molar ratio of trisisocyanatophenylmethane to dibutyltin dilaurate is 120:1. The solution was allowed to mix for 20 minutes. The resulting sol was then poured into molds and allowed to gel under a saturated acetone atmosphere. Gelation occurred within an hour and the gels are aged for 18 hours. After aging, the gels were solvent exchanged with methanol by soaking the gels in a bath of at least three times excess methanol relative to the volume of the gels for 24 h repeated three times over the course of three days.

The pore fluid in the gels was then exchanged with Novec 649, a low-surface-tension fluorinated solvent, by soaking in a bath of the target solvent having a volume five times that of the volume of the gels. The gels were then soaked in the bath for 24 hours. This was repeated five times over the course of five days. Alternatively, a continuous flow of the target solvent has been introduced over the gels.

Finally, the gels were dried by removing them from the low-surface-tension fluorinated organic solvent bath and allowing the solvent to evaporate from the gels resulting in polyurethane aerogels. Aerogels with a thickness of approximately 1 cm were obtained in as little as 20 min.

### Example 14. Preparation of a Polyurethane Aerogel Having a Density of 0.2 g/Cc

To 30 g of acetone was added 3.18 g of 85 w/w % trisisocyanatophenylmethane in ethyl acetate and 2.31 g of 1,1,1-tris(4-hydroxyphenyl)ethane. The solution was mixed until the monomers were dissolved. This formed a solution with a 0.4 M concentration of reactants in the solution. To this solution was added 0.074 mL of dibutyltin dilaurate catalyst to give a molar ratio of trisisocyanatophenylmethane to dibutyltin dilaurate is 120:1. The solution was allowed to mix for 20 minutes. The resulting sol was then poured into molds and allowed to gel under a saturated acetone atmosphere. Gelation occurred within an hour and the gels are aged for 18 hours. After aging, the gels were solvent exchanged with methanol by soaking the gels in a bath of at least three times excess methanol relative to the volume of the gels for 24 h repeated three times over the course of three days.

The pore fluid in the gels were then exchanged with Novec 7200, a low-surface-tension fluorinated organic solvent, by soaking in a bath of the target solvent having a volume five times that of the volume of the gels. The gels were then soaked in the bath for 24 hours. This was repeated five times over the course of five days. Alternatively, a continuous flow of the target solvent has been introduced over the gels.

Finally, the gels were dried by removing them from the low-surface-tension fluorinated organic solvent bath and allowing the solvent to evaporate from the gels resulting in polyurethane aerogels. Aerogels with a thickness of approximately 1 cm were obtained in as little as 20 min.

### Example 15. Preparation of a Polymer-Crosslinked Silica Aerogel Having a Density of 0.6 g/Cc

A silica gel was synthesized by the sol-gel process. First, a solution A was prepared by mixing 3.839 mL of tetramethoxysilane and 4.514 mL of methanol. A second solution B was prepared by mixing 4.514 mL of methanol, 1.514 mL of deionized water, and 0.020 mL of 15.1 M aqueous ammonium hydroxide. Both solutions were independently mixed for five minutes. Solution B was then poured into solution A and the combined solution was mixed for five minutes. The resulting sol was then poured into polypropylene molds. Gelation occurred within 30 to 45 minutes. The resulting gels were then solvent exchanged into a series of solvents by soaking the gels in baths containing at least three times the volume of the gels of the target solvent for 24 hours each in the following order: methanol, acetone, and acetonitrile (3×). The gels were then soaked in a bath of 20 w/w % Desmodur N3300 (aliphatic triisocyanate) in acetonitrile with a volume of 5× the volume of the gels. The gels were allowed to soak in this solution for 3 days at room temperature and 1 day at 80° C.

The crosslinked gels were then soaked for 24 hours in each of the following baths: acetonitrile, acetone, 3× Novec 7200, a low-surface-tension fluorinated organic solvent. Alternatively, a continuous flow of the target solvent has been introduced over the gels.

Finally, the gels were dried by removing them from the low-surface-tension fluorinated organic solvent bath and allowing the solvent to evaporate from the gels resulting in polymer-crosslinked silica aerogels. Alternatively, a flow of air, dry air, nitrogen gas, or carbon dioxide may be added. Aerogels with a thickness of approximately 1 cm were obtained in as little as 20 min.

### Comparative Example 16. Preparation of a Silica Aerogel Having a Density of 0.47 g/Cc

A silica gel was synthesized by the sol-gel process. First, a solution A was prepared by mixing 3.839 mL of tetramethoxysilane and 4.514 mL of methanol. A second solution B was prepared by mixing 4.514 mL of methanol, 1.514 mL of deionized water, and 0.020 mL of 15.1 M aqueous ammonium hydroxide. Both solutions were independently mixed for five minutes. Solution B was then poured into solution A and the combined solution was mixed for five minutes. The resulting sol was then poured into polypropylene molds. Gelation occurred within 30 to 45 minutes. The resulting gels were then solvent exchanged into methanol by soaking the gels in a bath containing at least three times the volume of the gel for 24 hours. The bath was changed three times over the course of three days. The gels were exchanged into a bath containing a hydrophobe of ethanol containing 30 v/v % hexamethyldisilazane and heated 60° C. for 2 d to make the gels hydrophobic. Following this hydrophobic treatment, the gels were then exchanged back into methanol.

The gels were then soaked in a bath of Novec 649, a low-surface-tension fluorinated organic solvent, having at least five times the volume of the gels for 24 hours. The bath was changed five times over the course of five days. The surface tension of the fluorinated organic solvent was low, about 10.8 dynes/cm. Alternatively, a continuous flow of the target solvent has been introduced over the gels.

Finally, the gels were dried by removing them from the low-surface-tension fluorinated organic solvent bath and allowing the solvent to evaporate from the gels resulting in silica aerogels. Alternatively, a flow of air, dry air, nitrogen gas, or carbon dioxide has been added. Aerogels with a thickness of approximately 1 cm were obtained in as little as 20 min. Aerogels tended to be very cracked and densified to 0.47 g/cc whereas the typical density of this formulation (dried via supercritical drying) is 0.13 g/cc.

### Comparative Example 17. Preparation of Polyurea Aerogel with Direct Solvent Exchange into Novec 7200 without Purification of Pore Liquid

A polyurea gel was prepared using the recipe outlined in Example 2. The first solvent exchange bath was omitted, and the gel was transferred directly to Novec 7200. Exchange into Novec 7200 and drying were performed as outlined in Example 2. The resulting aerogel has a density of 0.29, nearly 50% higher than the expected value. This densification is attributed to the presence of residual water in the pores of the gel, as it would not be removed by Novec 7200 since water and Novec 7200 are immiscible.

### Comparative Example 18. Preparation of Polyurea Aerogel with Insufficient Wait Time Between Novec 7200 Solvent Baths

Polyurea gels were prepared and subsequently solvent exchanged into methanol as described in Example 2. They were then placed in baths of Novec 7200 which were refreshed every 3, 6, 9, 12, or 24 hours. One sample was exchanged on a progressive cycle time such that it was in baths 1-5 for 1, 3, 5, 6, and 9 hours, respectively. Gels that had exchange times of 9, 12, and 24 hours were identical to the gels described in Example 2 after evaporative drying. For gels that had 3-hour or 6-hour solvent exchange times, it was observed that the interior core of the gel densified, while a layer around the outside dries as expected (the outer layer, once removed, had a density equivalent to that of the successfully dried materials). This is consistent with insufficient solvent exchange, and is commonly seen in materials dried using supercritical carbon dioxide when the alcohol within the pores is not given sufficient time to diffuse out.

After exchange into Novec 7200 (but before drying), the gels that had been exchanged with a progressive timing schedule had shrunk considerably (about 20% linearly). After drying the resulting aerogel had a density of 0.4 g/cc, approximately twice that expected. This failure mode is distinct from that seen in the gels which had been insufficiently solvent exchanged in that it is a homogeneous densification and it occurs before the actual drying step.

### Comparative Example 19. Preparation of Polyurea Aerogels Using Solvent Exchange into Excessively Large Volume of Novec 7200

Polyurea gels were synthesized following the recipe given in Example 2. After solvent exchange into methanol, the gels were transferred into three separate baths of Novec 7200. The Novec-to-gel volume ratios of these baths were 5:1, 37.5:1, and 115:1. All gels were dried the same way as described in Example 2. The gels in the 37.5:1 bath shrank 45% more than the gels in the 5:1 bath. The gels in the 115:1 bath shrank nearly 5 times more than the gels in the 5:1 bath. In both cases this shrinkage occurred before drying.

### Comparative Example 20. Preparation of Polyurea Aerogel with High Solvent Exchange Temperature

Polyurea gels were synthesized following the recipe given in Example 2. After solvent exchange into methanol, the gels were transferred into identical Novec 7200 solvent exchange baths. Both were exchanged as described in Example 2, but one of the baths was kept at 15° C. while the other was kept at 20° C. Both gels were then dried normally as described in Example 2. The gel that was solvent exchanged at 20° C. shrank nearly 80% more than the gel exchanged at 15° C.

### Comparative Example 21. Preparation of Polyurea Aerogel Solvent Exchanged Under Controlled Dry Atmosphere and Ambient Atmosphere with Atmospheric Moisture

Polyurea gels were synthesized following the recipe given in Example 2. After the second methanol exchange, one of the solvent exchange baths and the gel contained therein was moved to a dry nitrogen environment. The other remained in normal atmosphere. They remained in their respective atmospheres through the duration of the exchange into methanol and subsequent exchange into Novec 7200 as outlined in Example 2. Both gels were then dried as described in Example 2. The gels that were exchanged in ambient air underwent 40% more linear shrinkage than the gels exchanged under nitrogen.

### Comparative Example 22. Preparation of Polyurea Aerogels with Different Novec Solvents

Polyurea gels were prepared and subsequently solvent exchanged into methanol as described in Example 1. After methanol exchange, one gel was exchanged into Novec 7100 and one into Novec 7000, and then dried using the procedure described in Example 1. The gel dried from Novec 7100 was indistinguishable from the gel described in Example 1. Although Novec 7000 has a lower surface tension than Novec 7100, the gel dried from Novec 7000 had a final density nearly 20% higher than the gel dried from Novec 7100.

Additionally, polyurea gels were prepared as described in Example 1 for drying from Novec 649. The gels were exchanged through methanol as in Example 1. The gels were then transferred into acetone in a 5:1 volume ratio of gel volume to acetone. This exchange was done 5 times to remove methanol from the gel (<0.01% methanol) as alcohols react with Novec 649. The gels were then exchanged into and dried from Novec 649 (which has a lower surface tension than either Novec 7200, 7100, 7000) in the procedure described in Example 1. These gels densified dramatically during solvent exchange before drying, and had a final density that was 6.5 times that of the aerogel described in Example 1.

### Example 23. Separation of Novec 7200 from Methanol

Subsequent to the solvent exchange process described in Example 1 (the 5 solvent exchanges into Novec 7200), the contaminated Novec 7200 was recycled for re-use in creating more gels or aerogels. The Novec 7200 was contaminated with methanol in a volume ratio of about 1:26 after all five solvent exchange baths are combined. A volume ratio of 1:2 water to Novec (The Novec phase with 1:26 methanol to Novec content) was added to the Novec. The mixture was mixed vigorously, and Novec was pumped through a nozzle and circulated through the water for 15 min. The mixture was allowed to settle for 15 min and mixed again, and then allowed to settle for 2 hours. The denser Novec phase was drained from the bottom of a separatory funnel, and the density was measured to ensure the separation process was complete. This separation process was completed in a single step, as the water was able to absorb nearly all the methanol from the Novec 7200, enough that the recovered Novec performed equivalently to fresh Novec in subsequent drying processes, where, for example, drying gel materials from Novec contaminated with 0.83 v/v % methanol would typically result in additional shrinkage of gel materials when compared to fresh Novec.

Having thus described several aspects of various embodiments of the present disclosure, it is to be appreciated various alterations, modifications, and improvements will readily occur to those skilled in the art. Such alterations, modification, and improvements are intended to be part of this disclosure, and are intended to be within the spirit and scope of the present disclosure. Accordingly, the foregoing description and drawings are by way of example only.

TABLE 1
List of low-surface-tension fluorinated solvents and chemical properties.

| | | Molecular | Surface | Temperature | | Boiling | Vapor | | |
|---|---|---|---|---|---|---|---|---|---|
| | Trade | Weight | Tension | Coefficient | Freezing | Point | Pressure | | |
| Chemical Name | Names | (g/mol) | (dynes/cm) | (K⁻¹) | Point (° C.) | (° C.) | (kPa) | Flammability | Toxicity |
| 1-methoxyheptafluoropropane | Novec | 200 | 12.4 | 0.00219 | −122.5 | 34 | 64.6 | Nonflammable | Low |
| | 7000 | | | | | | | | |
| Methoxynonafluorobutane | Novec | 250 | 13.6 | | −135 | 61 | 26.8 | Nonflammable | Low |
| | 7100 | | | | | | | | |
| Ethoxynonafluorobutane | Novec | 264 | 13.6 | | −138 | 76 | 15.7 | Nonflammable | Low |
| | 7200/8200 | | | | | | | | |
| 3-methoxy-4- | Novec | 350 | 15 | | −38 | 98 | 6.0 | Nonflammable | Low |
| trifluoromethyldecafluoropentane | 7300 | | | | | | | | |
| 2-trifluoromethy1-3- | Novec | 414 | 16.2 | 0.00129 | −100 | 128 | 2.1 | Nonflammable | Very Low |
| ethoxydodecafluorohexane | 7500 | | | | | | | | |
| 1,1,1,2,3,3-hexafluoro-4-(1,1,2,3,3,3- | Novec | 346 | 17.7 | 0.00114 | −98 | 131 | | Nonflammable | Very Low |
| hexafluoropropoxy)-pentane | 7600 | | | | | | | | |
| 2,3,3,4,4-pentafluorotetrahydro-5- | Novec | 528 | 18 | 0.00111 | −50 | 167 | | Nonflammable | Very Low |
| methoxy-2,5-bis[1,2,2,2-tetrafluoro-1- | 7700 | | | | | | | | |
| (trifluoromethypethyl)ethyl]-furan | | | | | | | | | |
| Dodecafluoro-2-methylpentan-3-one | Novec | 316 | 10.8 | 0.0018 | −108 | 49.2 | 40.4 | Nonflammable | Very Low |
| | 1230/649/6 | | | | | | | | |
| | 12 | | | | | | | | |
| Tetradecafluoro-2-methylhexan-3-one | Novec 774 | 366 | 12.3 | 0.0015 | −78 | 74 | 15.7 | Nonflammable | Very Low |
| (35-45 w/w %) /tetradecafluoro-2,4- | | | | | | | | | |
| dimethylpentan-3-one (55-65 w/w %) | | | | | | | | | |
| Tetradecafluorohexane (90-100 | Fluorinert | 338 | 10 | 0.00156 | −90 | 56 | 30.9 | Nonflammable | Practically |
| w/w %)/perfluoropetane (0-10 | FC-72 | | | | | | | | Non-Toxic |
| w/w %)/perfluorobutane (0-5 w/w/%) | | | | | | | | | |
| 2,3-dihydrodecafluoropentane | Vertrel XF | 252 | 14.1 | | −80 | 55 | 30.1 | Nonflammable | Low |

1. A method of making an aerogel material, comprising:
forming a porous gel material comprising an initial solvent;
contacting an organic solvent and the gel material such that organic solvent displaces initial solvent within pores of the gel material, the organic solvent comprising methoxynonafluorobutane and/or ethoxynonafluorobutane; and
evaporating the organic solvent from the pores of the gel material to produce the aerogel material;
wherein:
the aerogel material comprises a polymer and/or a polymer-crosslinked oxide, and
the gel material is free of water or contains water in an amount of no more than about 1.0 v/v % when the organic solvent contacts the gel material.

2-16. (canceled)

17. The method of claim 1, wherein the gel material comprises a network including at least one of a polyurea, a polyamide, a polyurethane, a polyimide, and a polymer-crosslinked oxide with a density of between 0.15 g/cc and 0.7 g/cc.

18-22. (canceled)

23. The method of claim 1, wherein the aerogel material has a compressive modulus of between about 300 kPa and about 1 GPa.

24-34. (canceled)

35. The method of claim 1, wherein the aerogel material is monolithic.

36. The method of claim 1, wherein the aerogel material has at least one dimension greater than about 30 cm.

37-43. (canceled)

44. The method of claim 1, wherein the evaporating step is performed when the surrounding atmosphere is at a temperature of between about 0° C. and about 50° C.

45. The method of claim 1, wherein the gel material, and the gel material is free of water or contains water in an amount of no more than about 0.01 v/v % when the organic solvent contacts the gel material.

46. The method of claim 1, wherein the gel material is at a temperature of between about 0° C. and about 20° C. at the point in time at which the organic solvent contacts the gel material.

47. (canceled)

48. The method of claim 1, wherein after the organic solvent contacts the gel material, the organic solvent contains impurities, and further comprising contacting the organic solvent with water after the organic solvent contacts the gel material, resulting in transfer of impurities from the organic solvent to the water to produce a recovered organic solvent containing less than 1 v/v % impurities.

49. The method of claim 48, wherein the recovered organic solvent is used to make a second gel material or aerogel.

50-56. (canceled)

57. A method of making an aerogel material, comprising:
reacting monomers together in the presence of a solvent to form a gel material comprising a network including at least one of a polyurea, a polyamide, a polyurethane, a polyimide, and a polymer-crosslinked oxide;
replacing the solvent with an organic solvent by contacting the organic solvent and the gel material, the organic solvent comprising methoxynonafluorobutane and/or ethoxynonafluorobutane; and
evaporating the organic solvent from the pores of the gel material to produce the aerogel material;
wherein the gel material is free of water or contains water in an amount of no more than about 1.0 v/v % when the organic solvent contacts the gel material.

58-95. (canceled)

96. A method of making an aerogel material, comprising:
providing a gel material, the gel material having an organic solvent in the pores of the gel material, and the organic solvent including at least a carbon atom and a fluorine atom;
evaporating the organic solvent from the pores of the gel material to produce an aerogel material, the aerogel material comprising a polymer and/or a polymer-crosslinked oxide;
recapturing the evaporated organic solvent vapor; and
condensing the organic solvent vapor,
wherein at least one dimension of the aerogel material is within about 50% of a corresponding dimension of the gel material.

97. The method of claim 96, wherein the organic solvent further includes a hydrogen atom.

98. The method of claim 96, wherein the organic solvent is free of non-fluorine halogen atoms.

99. (canceled)

100. The method of claim 96, wherein the organic solvent is used to make a second gel material.

101-106. (canceled)

107. The method of claim 1, wherein at least one dimension of the aerogel material is within about 50% of a corresponding dimension of the gel material.

108. The method of claim 35, wherein the aerogel material is substantially crack-free.
